(19) United States
(12) Patent Application Publication
(10) Pub. No.: US 2019/0052791 A1
(43) Pub. Date: Feb. 14, 2019

(54) IMAGE PROCESSING APPARATUS AND IMAGE PROCESSING METHOD

(71) Applicant: Olympus Corporation, Tokyo (JP)

(72) Inventors: Tetsuya Toyoda, Hachioji-shi (JP); Kazuhiko Osa, Hachioji-shi (JP); Osamu Nonaka, Sagamihara-shi (JP)

(21) Appl. No.: 16/054,934

(22) Filed: Aug. 3, 2018

(30) Foreign Application Priority Data
Aug. 10, 2017 (JP) 2017-155912
Aug. 22, 2017 (JP) 2017-159567

(51) Int. Cl. H04N 5/235; H04N 5/232

(52) U.S. Cl. CPC H04N 5/2355; H04N 5/23245; H04N 5/23296; H04N 5/23229

(57) ABSTRACT

An image processing apparatus includes a data processor configured to perform image processing to image data acquired from an imaging unit. The data processor includes an image acquisition unit configured to sequentially acquire image data from the imaging unit, an image analyzer configured to update a region-specific correction map including correction information on each of regions set for an imaging range of the imaging unit, based on at least two frames of image data acquired by the image acquisition unit, and a recording image data generator configured to generate recording image data in which one frame of image data acquired by the image acquisition unit is corrected based on the region-specific correction map.

### CROSS-REFERENCE TO RELATED APPLICATIONS

This application is based upon and claims the benefit of priority from prior Japanese Patent Applications No. 2017-155912, filed Aug. 10, 2017; and No. 2017-159567, filed Aug. 22, 2017, the entire contents of both of which are incorporated herein by reference.

### BACKGROUND OF THE INVENTION

### 1. Field of the Invention

The present invention relates to an image processing apparatus and an image processing method.

### 2. Description of the Related Art

Some recent imaging apparatuses have an HDR image recording function of acquiring an image with a wider dynamic range than the original imaging apparatus specification by synthesizing images with different exposure conditions. For example, Jpn. Pat. Appln. KOKAI Publication No. 2015-15622 discloses one of imaging apparatuses having such an HDR image recording function.

The HDR image is created by synthesizing temporally continuous frames of image data while changing image acquisition conditions (photographic parameters). In addition to performing synthesis processing to frames of image data at the time of photographing, if the similar processing is applied to the live view, the same effect can be obtained when observing an object, so that the visibility can be improved. In addition, since the live view image is created from continuous frames of image data, it is possible to obtain image data as if photographic parameters are changed by adding frames of image data at adjacent timings. If the image acquisition can be performed under various conditions at the time of live view, the information amount when confirming the features of the object (performing image analysis) using the result increases, so that the characteristics of the scene and the object can be more accurately determined. Therefore, image synthesis may be performed based on the result, but it is also possible to obtain an image with high quality without image synthesis. In order to decide the parameters at the time of photographic according to various situations, it is desirable to utilize a lot of information. Here, it is aimed to provide an image processing apparatus and an image processing method configured to obtain an optimum image corresponding to a photographing situation and a subject, by using rich information obtained at the time of image observation to judge the situation of imaging.

### BRIEF SUMMARY OF THE INVENTION

An image processing apparatus according to the present invention includes a data processor configured to perform image processing to image data acquired from an imaging unit. The data processor includes an image acquisition unit configured to sequentially acquire image data from the imaging unit, an image analyzer configured to update a region-specific correction map including correction information on each of regions set for an imaging range of the imaging unit, based on at least two frames of image data acquired by the image acquisition unit, and a recording image data generator configured to generate recording image data in which one frame of image data acquired by the image acquisition unit is corrected based on the region-specific correction map.

An image processing method according to the present invention is a method of performing image processing to image data acquired from an imaging unit. The method has sequentially acquiring image data from the imaging unit, updating a region-specific correction map including correction information on each of regions set for an imaging range of the imaging unit based on at least two frames of image data acquired, and generating recording image data in which one frame of image data acquired is corrected based on the region-specific correction map.

Another image processing apparatus according to the present invention includes a data processor configured to perform image processing to image data acquired from an imaging unit. The data processor includes an image acquisition unit configured to sequentially acquire image data from the imaging unit, and an image analyzer configured to analyze images for each of regions set for an imaging range of the imaging unit based on at least two frames of image data acquired by the image acquisition unit.

Another image processing method according to the present invention is a method of performing image processing to image data acquired from an imaging unit. The method has sequentially acquiring image data from the imaging unit, and analyzing images for each of regions set for an imaging range of the imaging unit, based on at least two frames of image data acquired.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of an imaging system including an image processing apparatus according to a first embodiment.

FIG. 2A shows the first half of a flowchart of the photographing process in the imaging system shown in FIG. 1.

FIG. 2B shows the last half of the flowchart of the photographing process in the imaging system shown in FIG. 1.

FIG. 3 is a timing chart showing the operation at the start of imaging in the imaging system shown in FIG. 1.

FIG. 4 illustrates a manner of image correction using a region-specific correction map.

FIG. 5 is a diagram showing the structure of the region-specific correction map.

FIG. 6A is a diagram showing the structure of a still image file.

FIG. 6B is a diagram showing the structure of a moving image file.

FIG. 7 is a block diagram showing the configuration of an imaging system including an image processing apparatus according to a second embodiment.

FIG. 8A shows the first half of a flowchart of the photographing process in the imaging system shown in FIG. 7.

FIG. 8B shows the last half of the flowchart of the photographing process in the imaging system shown in FIG. 7.

FIG. 9 is a timing chart showing the operation at the start of imaging in the imaging system shown in FIG. 7.

FIG. 10 is a block diagram showing the configuration of an imaging system including an image processing apparatus according to a third embodiment.

FIG. 11A shows the first half of the flowchart of the photographing process in the imaging system shown in FIG. 10.

FIG. 11B shows the last half of the flowchart of the photographing process in the image pickup system shown in FIG. 10.

FIG. 11C is a flowchart of processing for updating the region-specific correction map shown in FIG. 11A.

FIG. 11D is a flowchart of the process of generating recording image data of a moving image shown in FIG. 11B.

FIG. 11E is a flowchart of the process of generating recording image data of a still image shown in FIG. 11B.

FIG. 12 is a timing chart showing the operation at the start of imaging in the imaging system shown in FIG. 10.

FIG. 13A is a diagram showing the structure of a still image file.

FIG. 13B is a diagram showing the structure of a moving image file.

FIG. 14 is a block diagram showing the configuration of an imaging system including an image processing apparatus according to a fourth embodiment.

FIG. 15A shows the first half of a flowchart of the photographing process in the imaging system shown in FIG. 14.

FIG. 15B shows the last half of the flowchart of the photographing process in the imaging system shown in FIG. 14.

FIG. 15C is a flowchart of the process of modifying the photographic condition shown in FIG. 15A.

FIG. 15D is a flowchart of the process of generating recording image data of a moving image shown in FIG. 15B.

FIG. 15E is a flowchart of the process of generating recording image data of a still image shown in FIG. 15B.

FIG. 16 is a timing chart showing the operation at the start of photographing in the imaging system shown in FIG. 14.

### DETAILED DESCRIPTION OF THE INVENTION

### First Embodiment

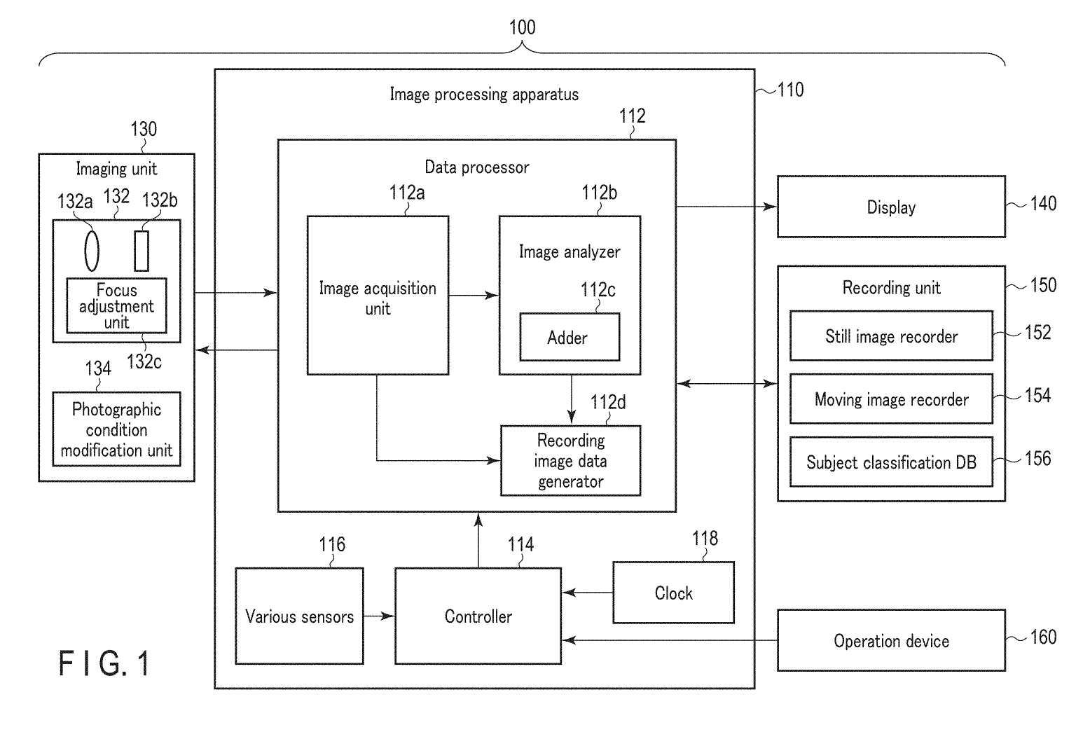

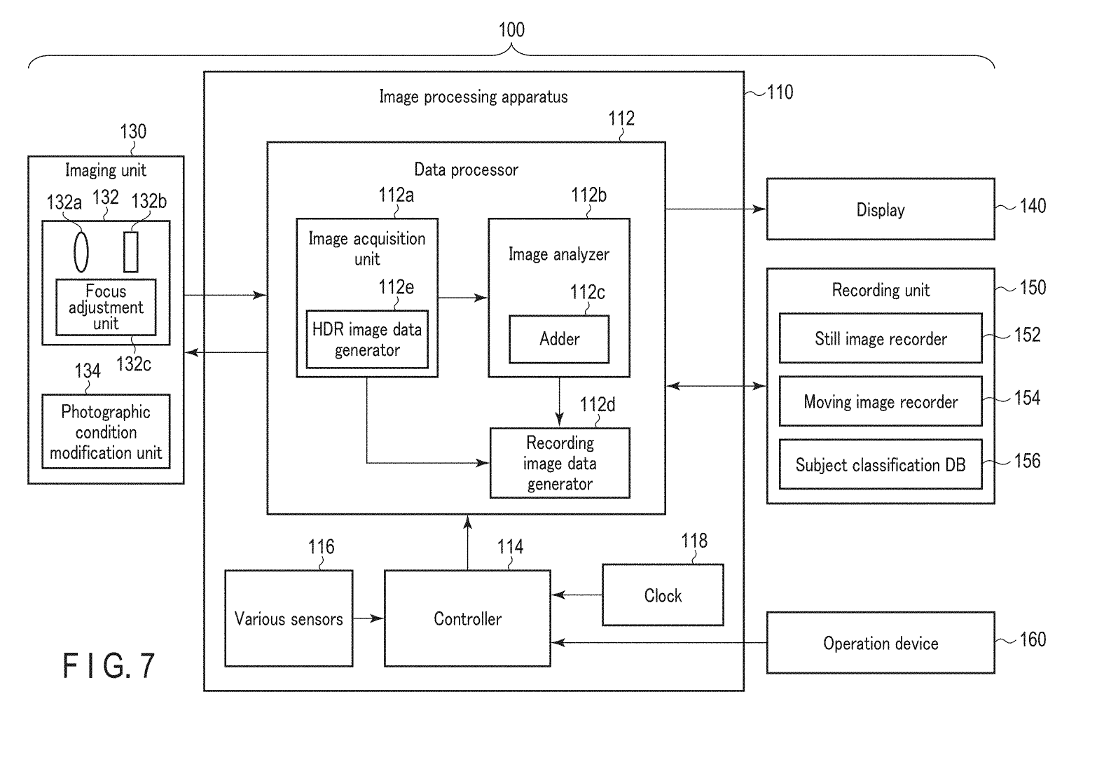

Hereinafter, a first embodiment will be described with reference to the drawings. FIG. 1 is a block diagram showing the configuration of an imaging system including an image processing apparatus according to the first embodiment. An imaging system 100 shown in FIG. 1 may include various devices having imaging functions, such as a digital camera, a smartphone, or a mobile phone with a camera function. In addition to FIG. 1, in the present application, FIGS. 7, 10, and 14 also show the block diagrams. The figures are specialized for explaining the respective embodiments. In the embodiments, the essential difference is small and information prior to photographing is used effectively.

An HDR image is created by synthesizing temporally continuous frames of image data immediately after the timing of issuance of a photographing instruction. For this reason, it is hard to strictly say that the HDR image is an image where a decisive moment is captured.

In view of such a situation, the present embodiment is intended to acquire a high-quality recorded image with high visibility at a certain momentary in time.

The imaging system 100 includes an imaging unit 130 configured to generate image data, an image processing apparatus 110 configured to acquires the image data from the imaging unit 130 to process the image data, a display 140 configured to acquire information such as images from the image processing apparatus 110 to display the information, a recording unit 150 configured to acquire the information such as images from the image processing apparatus 110 to record the information, and an operation device 160 for operating the imaging system 100.

These components of the imaging system 100, i.e., the imaging unit 130, the image processing apparatus 110, the display 140, the recording unit 150, and the operation device 160 are each composed of, for example, a combination of hardware and software. Each component of the imaging system 100 may not be composed of a single piece of hardware or software and may be composed of pieces of hardware or pieces of software.

The image processing apparatus 110, the imaging unit 130, the display 140, the recording unit 150, and the operation device 160 are configured so that the image processing apparatus 110 can communicate information with each of the imaging unit 130, the display 140, the recording unit 150, and the operation device 160. Communication of information may be performed by wired communication or wireless communication.

Although the image processing apparatus 110, the imaging unit 130, the display 140, the recording unit 150, and the operation device 160 are illustrated as separate elements from one another in FIG. 1, the image processing apparatus 110 may comprise one or some or all of the imaging unit 130 and the display 140, the recording unit 150, and the operation device 160.

The imaging unit 130 is configured to sequentially generate and output image data.

The image processing apparatus 110 has a function of sequentially acquiring image data from the imaging unit 130 and performing image processing to the acquired image data as necessary.

The display 140 is configured to display information provided from the image processing apparatus 110.

The recording unit 150 is configured to record information provided from the image processing apparatus 110 and to provide the recorded information to the image processing apparatus 110.

The operation device 160 is configured to allow a user to operate the imaging system 100. Of course, the imaging system 100 may be operated under specific conditions such as that of surveillance cameras.

Hereinafter, the configurations of the image processing apparatus 110, the imaging unit 130, the display 140, the recording unit 150, and the operation device 160 will be described in detail.

<Imaging Unit 130>

The imaging unit 130 includes an imager 132 configured to sequentially form an optical image based on incoming light and sequentially output a frame of electrical image data corresponding to the formed optical image. The imager 132 includes an imaging optical system 132a, an imaging element 132b, and a focus adjustment unit 132c. The imaging optical system 132a includes an aperture, a lens, and the like, and focuses incoming light to bring it on the imaging element 132b. The imaging optical system 132a further includes a focus lens for adjusting the in-focus state. The imaging element 132b includes, for example, a CMOS image sensor or a CCD image sensor, and acquires image data (RAW image data) relating to an optical image formed by the imaging optical system 132a. The imaging element 132b may include a phase difference detection pixel so as to detect the distance to an object to be photographed. The imaging element 132b in the present embodiment may be configured to be movable within a plane orthogonal to the optical axis of the imaging optical system 132a. In accordance with a focus control signal supplied from the data processor 112, the focus adjustment unit 132c drives the focus lens of the imaging optical system 132a in its optical axis direction and drives the imaging element 132b.

The imaging unit 130 also includes a photographic condition modification unit 134 configured to modify photographic conditions of the imager 132 according to the information of the photographic conditions supplied from the image processing apparatus 110. The photographic condition modification unit 134 has a function of modifying the exposure, for example, by adjusting the aperture of the imaging optical system 132a or the exposure time of the imaging element 132b. The photographic condition modification unit 134 may have a function of modifying other photographic conditions in addition to the exposure.

The imaging unit 130 further includes an unillustrated attitude detection sensor that detects the attitude of the imaging unit 130. The attitude detection sensor is, for example, composed of a gyro sensor.

<Display 140>

The display 140 is composed of, for example, a liquid crystal display or an organic EL display. For example, the display 140 sequentially displays image data supplied from the image processing apparatus 110. In addition to the image data, the display 140 also displays various kinds of information supplied from the image processing apparatus 110.

<Operation Device 160>

The operation device 160 is a device configured to allow a user to operate the imaging system 100. The operation device 160 has, for example, a release button, a moving image button, a setting button, a selection key, a start/stop button, a touch panel, and the like. The release button is an operation element for instructing still image photographing. The moving image button is an operation element for instructing a start and an end of moving image photographing. The setting button is an operating element for causing the display 140 to display the setting screen of the imaging system 100. The selection key is an operation element for selecting and determining items on the setting screen, for example. The start/stop button is an operation element for instructing a start and a stop of the image processing apparatus 110. The touch panel is provided integrally with the display screen of the display 140 and is an operation element for detecting a touch operation by the user on the display screen. The touch panel may be configured to perform the same operations as those of the release button, the moving image button, the setting button, the selection key, and the start/stop button. The operation device 160 may further include other operation elements other than those described herein, for example, operation elements corresponding to gesture detection, wireless response, remote instructions, and the like.

<Recording Unit 150>

The recording unit 150 is composed of, for example, a flash memory. The recording unit 150 has a function of recording an image file supplied from the image processing apparatus 110. The recording unit 150 includes a still image recorder 152 configured to record a still image file and a moving image recorder 154 configured to record a moving image file. The recording unit 150 also includes a subject classification database (DB) 156 showing the relationship between a subject and correction information, and has a function of providing information of the subject classification database 156 to the image processing apparatus 110 as necessary.

The subject classification database 156 classifies what the subject is in order to determine the relationship between the subject and correction information, and may have a dictionary stating that it is preferred to classify such a subject in such a way. Of course, the subject classification database 156 may be created by simply determining and recording a threshold value when a user performs classification of information, for example, a bright subject is classified in this way, and a dark subject is classified in this way. The subject classification database 156 may also be a database reflecting color components, for example, a subject having characteristics such as red or blue. The most sophisticated one may associate shape information and color distribution information such as “This is a seagull, so it has this appearance when it flies or has this appearance when it stops”, with the name information of “seagull”. Such a subject classification database can be created by using a technique such as face detection. The subject classification database may also be a database from which “seagulls” can be searched from motion information of “how to fly”, such as how the shape of the wings change. The database can also be updated or renewed by machine learning. Furthermore, as will be described later, the subject classification database may be configured such that scenes or composition information, such as a specific scene and a face in a specific composition preferred by a photographer, may be inserted into itself. With the database created in this way, it is possible to determine what the object is from the image. Most typically, it results in a source based on the idea such as “This is a seagull, so I want to reproduce it in white” or “This is a sunflower, so make a correction to make it becomes yellowish”. However, since a backlighted “seagull” in the blue sky is not white, in this case, a scene determination result, etc. may also be reflected. In the simplest way, a user would like to make corrections such as “make it darker, because it is too bright here to make a correction for emphasizing the original color”, and thus as mentioned above, it may be a database only enabling the classification “this spot is dark” and “this spot is bright”. The subject classification database may be a database that can be customized by causing it to remember a subject the user adheres to such as “making corrections so that the subject can be reproduced with a contrast, gradation, and color expression like this”. Such a database may be created by machine learning. If the user is aiming at the same subject many times, the features of the subject can be input, and at that time, if the photographer accumulates data while detecting an operation member for adjusting photographic parameters that has been operated with special care by the photographer or while determining the operation amount, it is possible to determine and learn about what kind of particular image can be obtained under a similar situation (composition, light adjustment, etc.). Since an image erased by a user does not meet such needs, it may be determined to be, and handled as an image that must not be studied as a model image so that the user can learn. Database customization may be performed with a program that carries out such functions. Simply speaking, the subject classification database 156 has information on various kinds of features on images specific to a subject so long as there is associated information such as what it is and how it should be handled, it may also be expressed as having correction information suitable for each subject.

Furthermore, the recording unit 150 may hold various kinds of information used for controlling the imaging system 100 and information on users. With such a database, a feature portion that is within an image region may be known, making it possible to create a region-specific correction map, which will be described later.

<Image Processing Apparatus 110>

The image processing apparatus 110 is generally composed of an integrated circuit and is integrated in a configuration in which various functions are easy to use, and includes a data processor 112 configured to acquire an image from the imaging unit 130, and to perform, to the acquired image data, image processing determined by a specific program in accordance with the situation, an image, etc., or in accordance with the user's instructions. The image processing apparatus 110 also includes a controller 114 configured to control the data processor 112, various sensors 116 configured to acquire various information on sensing a user operation, a photographing environment, etc., and a clock 118 configured to provide date and time information. The controller 114 performs control based on a program recorded in the recording unit, etc. according to the operation or the obtained data, and controls the entire sequence.

<Data Processor 112>

The data processor 112 is configured to perform image processing to the image data acquired from the imaging unit 130. The data processor 112 is configured to generate recording image data from the image data acquired from the imaging unit 130 and to output the generated image data to the recording unit 150. For example, the data processor 112 is also configured to generate a focus control signal by image processing, and to output it to the imaging unit 130.

The data processor 112 controls general image processing, and adjusts the reproducibility of color and contrast, adjusts the picture quality of the display and photographed image by adjusting the reproducibility of color and contrast, performs correction by various filters, and performs exposure compensation, etc. The data processor 112 also corrects distortion and aberration caused by the optical system, and also refers to optical performance for this purpose. Herein, units that are strongly related to the present invention are described explicitly, but it goes without saying that there are many other functions besides this. The configuration is simplified to simplify the explanation. The data processor 112 noted in this embodiment includes an image acquisition unit 112a configured to acquire image data from the imaging unit 130, an image analyzer 112b configured to analyze the image data acquired by the image acquisition unit 112a, and a recording image data generator 112d configured to generate image data for display, observation, viewing, and recording based on the image data that has been obtained by the image acquisition unit 112a and the analysis result by the image analyzer 112b. This part handles image data, and needs to perform various calculations at high speed, and it is distinguished to some extent from sensors, controllers and others.

<Image Acquisition Unit 112a>

In addition to simply acquiring image data from the imaging unit 130, the image acquisition unit 112a can switch the mode of data reading, for example, at the time of capturing a still image, at the time of capturing a moving image, at the time of live view display, or at the time of taking out a signal for autofocus. Furthermore, the image acquisition unit 112a can change the exposure time etc., such as the accumulation of optical signals, at the time of forming imaging data (image data), and perform divisional readout, mixed readout, etc. of pixels as necessary. The image acquisition unit 112a also sequentially acquires image data to cause the display 140 to display the image data without delay at the time of live view used when a user confirms an object. The image acquisition unit 112a sequentially outputs the image data subjected to the image processing in this way to the image analyzer 112b.

<Image Analyzer 112b>

The image analyzer 112b stores region-specific correction maps. The image analyzer 112b has a function of causing the recording unit 150 to store the region-specific correction map therein, instead of storing the region-specific correction maps in the image analyzer 112b itself, and reading a region-specific correction map from the recording unit 150 when necessary. Information on the region-specific correction map can also be reflected on images other than the analyzed image itself.

The region-specific correction map includes position information of the imaging region of the imaging unit 130 and correction information on each of the regions of the imaging unit 130. The region-specific correction map has position (distribution) information within the screen of the image region, classified for each image region by analyzing the imaging result of the imaging unit 130 by the subject classification database 156. The region-specific correction map is created by recording a picture making expression expected from image features for each of the regions, and has, as correction information, a result of determining whether or not any processing is effective for picture making (color expression, gradation, noise, contrast, etc.) required for the region according to the image features of each region.

In other words, the region-specific correction map can also be said to be a map obtained by analyzing and mapping images corresponding to the each frame of image data successively taken, for example, during display of a live view output from the imaging unit 130. By modifying photographic parameters of the captured image, it is possible to increase the information amount of the object determination in the image and to improve the accuracy, and it is possible to determine a difference between an intended image in which it is better to express in such a matter for each region of the image and an image that could be obtained as-is for each region of the image to obtain information (correction information) on measures to eliminate or reduce the difference. Of course, as a result of detection of the object, it is acceptable for those not requiring visibility not be corrected. The present embodiment is intended to increase the amount of information when recognizing an object by modifying a photographic condition, so that the present application can also be used even in applications that warn or display that something has been detected. Since a live view image is obtained at a speed of 30 frames per second or 60 frames per second, it has a very large amount of information and high real-time performance. This includes correction information that can reduce the difference from the ideal for each pixel in a small unit or for a region of images having similar features in a unit slightly wider than the small unit. Image processing optimized for each region of the image can be performed by sequentially reflecting this also on the display of the live view image and the like. That is, according to the present embodiment, it is possible to provide the image processing apparatus 110 in which the data processor 112 configured to perform image processing to the image data acquired from the imaging unit 130 includes the image analyzer 112b configured to analyze images for each of regions set for the imaging range of the imaging unit 130 based on at least two types of frames of image data acquired by the image acquisition unit 112a under different photographic conditions.

The image analyzer 112b may perform image analysis by adding the image data, based on temporally continuous frames of image data acquired by the image acquisition unit 112a. In the case of a live view image, since image data is read out at a fairly high speed, a large amount of information can be obtained, so it is an approach of effectively utilizing it. Since the light signals are integrated by the addition, something that could not be seen may become visible, and it can also be determined that the noise is canceled by the integration and there is no noise. If necessary, by modifying the photographic conditions, it is possible to shorten the accumulation time, to mix pixels, to acquire information on focusing and information on perspective, and to determine where a specific image pattern of image is present such as that of human face detection technology. It is possible to analyze changes in framing, changes in objects, etc. using differences in images obtained one by one (for each frame), and to analyze such movements as well. When the object has changed, since the map is different from the assumed scene, it becomes impossible to use the map, so the region-specific correction map is updated. However, if the change is somewhat small, there are cases where it is possible to perform synthesis by superimposing the corresponding portions such as that of an approach for electronic camera shake correction or subject tracking, and in this case, there is no need to perform map updating.

Herein, updating the region-specific correction map means rewriting information of the region-specific correction map into useful information. That is, although resetting the region-specific correction map, in other words, erasing information of the region-specific correction map rewrites the information of the region-specific correction map, because of the difference in information after rewriting; this is not included in updating the correction map. There is also information that can be obtained from a difference in information before and after rewriting when the region-specific correction map is updated, such as a change in framing, a pattern of the framing, and the characteristics of movements of the object. By the region-specific correction map, a display image, an observation image, a recorded image, and the like can be optimized, and the effect of facilitating the determination of a specific object appearing in an image can be obtained. If the feature of each region is known using a preliminarily obtained image, it enables an expression where the performance of image analysis improves in the succeeding images by using the result.

If the subject to be photographed does not change, it is considered that the information at that time (prior to photographing) can be effectively used for images to be photographed subsequently, and it makes sense to create a correction map. There is information that can be analyzed with one (frame of) image, and some information can be analyzed with multiple frames like a dark scene. Images obtained in different imaging modes may be used as necessary. For example, in the case of reflecting image information such that the perspective distribution is discerned, it may be used for region segmentation. This is a process of reflecting image information, but the process itself is different from addition and is an example of using information of (frames of) images.

In order to update the region-specific correction map, the image analyzer 112b has a function of temporarily accumulating a predetermined fixed number of frames of image data necessary for updating the region-specific correction map. The fixed number of frames of image data accumulated by the image analyzer 112b may be updated every time a new frame of image data is input from the image acquisition unit 112a, or may not be updated if frames of accumulated data are insufficient. The analysis may be carried out each time image data is accumulated, or may be carried out after image data is accumulated, but many characteristics can be analyzed if the analysis is carried out for each accumulation. The accumulated data is updated as the scene changes, and if there is a region that cannot be analyzed, or when switching to another imaging mode. Among the fixed number of frames of image data accumulated by the image analyzer 112b, the oldest single frame of image data is discarded or erased, and instead, image of a newly input single frame is accumulated, i.e., stored. With such an approach, image analysis can be performed at the timing closest to photographing.

Instead of having a function of temporarily accumulating a predetermined fixed number of frames of image data, the image analyzer 112b may have a function of temporarily accumulating a predetermined fixed number of frames of image data in the recording unit 150, and reading the predetermined fixed number of frames of image data from the recording unit 150 when necessary.

The frames of image data used for updating the region-specific correction map may be at least two frames of image data. In addition, the image data used for updating the region-specific correction map may be several frames of image data among temporally continuous frames of image data. Furthermore, these several frames of image data may not be temporally continuous.

The image analyzer 112b includes an adder 112c configured to perform, for example, addition processing to the frames of image data accumulated by the image analyzer 112b in order to update the region-specific correction map. The addition may be performed when the amount of information is insufficient in an image. The scene is determined, and image data in different photographic conditions (pixel shift for super-resolution and exposure shift enlarging a dynamic range) may be used for addition. Such control may be performed by the image acquisition unit 112a. In other words, the easiness of detection during recognizing an object is improved by modifying the photographic conditions including a presence or an absence of accumulation of data to increase the amount of information of obtained image data, and it is possible to further improve the visibility of images, image determination, and analysis performance using the improved ease of detection. In the present embodiment, the “amount of information” is used assuming that the volume of data is further increased for data having a limited data volume, and determination accuracy is improved by making a determination over and over, and so on, even if the data has a limited data volume. In the case of acquiring information many times, since it is possible to obtain an amount of information with meaningful differences when accompanied by a modification of various conditions at the time of photographing (at the time of acquiring image data), the effect of the present embodiment is further increased.

Herein, for the sake of convenience, a portion within the image analyzer 112b configured to perform processing to image data in order to update the region-specific correction map is referred to as “adder 112c”; however, the processing performed by the adder 112c is not limited to addition processing, and the adder 112c may perform processing other than the addition processing. The above-mentioned “adder 112c configured to perform addition processing” has such a meaning.

The adder 112c performs addition processing to each pixel or each region of discretionary j frames (j=2, . . . , i) of image data included in i frames (i is a natural number of 2 or more) of image data. For example, the adder 112c performs addition processing of two frames of image data and addition processing of image data of three frames to three temporally continuous frames of image data. If two frames are not sufficient, the third frame can also be used for analysis.

The j frame (j<i) of image data used for the addition processing may be image data that is temporally continuous or image data that is not temporally continuous. When there is a frame that is difficult to use for analysis in the middle of temporally continuous image data, for example, when there is a frame for autofocus, the image data that is difficult to use for analysis may not be added to image data to be used for addition processing. Of course, the image data that is difficult to use for analysis may be used as image data for addition processing.

The adder 112c has a function of temporarily accumulating image data obtained by the addition processing. Instead of having such a function, the adder 112c may have a function of temporarily accumulating the image data obtained by the addition processing in the recording unit 150, and reading the image data obtained by the addition processing from the recording unit 150 when necessary.

If it is possible to analyze what color is used here, and what color is used there, or what kind of gradation is used here, and what kind of gradation is used there, etc., without using addition processing, the addition function is not required. In most cases, the dynamic range of an image is wide, and thus it is often difficult to ascertain the entire image in a single process of photographing. For example, in a tunnel, an image outside the tunnel is too bright and an image of the wall surface of the tunnel is too dark, and therefore, even if it is possible to determine that the outside of the tunnel is a green forest without adding an image of the outside, the accumulated amount of the image is insufficient in order to determine to the extent that the tunnel wall is gray or beige, so that the addition processing is performed. Instead of adding the entire image, only necessary portions may be added. In that case, optimum data remains on the entire screen even after the addition, and furthermore it is possible to make an overall determination where the entirety of the image is unified.

In this way, region-specific correction data can be created. In other words, the gain may be increased so that the tunnel part comes close to the obtained data, or the balance of the color components may be adjusted. If the part outside the tunnel is green, it is only necessary to emphasize such a color so that it can be recognized as being green. If it is too bright and the greenish colors are decreasing, a correction to reduce the gain may be made. If each part excessively asserts its characteristics, it will result in unnatural coloring with the appearance of colored paper stuck together, so additional processing that makes them look balanced and natural may be done. At this time, it is only necessary to analyze the bright/dark change of each part and provide a bright/dark balance that would come close to the analysis result of the entire image.

In this specification, it is stated that a subject classification database is used; however, it is not necessary to classify an object in this way by identifying the object, such as this part is an inner part of the tunnel, this part is an outer part of the tunnel, etc. It is enough that parts of an image can be classified as “a part that needs a gain increase, because the amount of data is small” and “a part that is bright, needs no gain increase and is to be green-colored”. Since randomly generated noise is averaged by the addition of information, when there is no change in the image in the result of the addition and there is a change in the image in the pre-addition information, this can be determined as noise. In other words, in such a case, in the subject classification database, a part having a noise becomes “a dark part”, and the “region-specific correction map” becomes a map for allowing the recording image data generator 112d to perform a process “to make the dark part remain dark; however the contrast is lowered so that the noise is not visible”.

In the following description, in order to make it easier to distinguish between image data to be subjected to the addition processing and image data obtained by the addition processing, the image data to be subjected to the addition process is referred to as original image data, and the image data obtained by the addition processing is referred to as added image data, as needed.

The image analyzer 112b updates the region-specific correction map based on one frame of image data continuously obtained, and if necessary, added image data in which an image is further added to the one frame of image data, etc.

In the case where due to the darkness of the screen, sufficient information such as what kind of characteristics each region of the screen has cannot be obtained, the amount of information can be obtained by synthesizing; however, in the case of an image with uniform brightness, there are cases where synthesis is not required. In the case where the gradation is subtle, it is sometimes easier to ascertain the gradient by adding image data, and it is also meaningful to perform addition processing and determine the image data at the time except when an image in the screen is dark.

For example, the image analyzer 112b updates the region-specific correction map based on one frame of original image data included in the i frames of original image data and (i−1) frame/s of added image data obtained by addition processing of the j frames (j=2, . . . , i) of original image data. As a specific example, the image analyzer 112b updates the region-specific correction map based on one frame of original image data included in the three frames of original image data, one frame of added image data obtained by addition processing of the two frames of original image data, and one frame of added image data obtained by addition processing of the three frames of original image data.

For updating the region-specific correction map, an example is given in which one frame of original image data included in the i frames of original image data and one frame of added image data obtained by each addition processing of the j frames of original image data are used; however, additional frames of image data may be used. For example, in the above-described specific example, in the updating of the region-specific correction map, two or more frames of original image data included in the three frames of original image data, two or more frames of added image data obtained by addition processing of the two frames of original image data, and one frame of added image data obtained by the addition processing of the three frames of original image data, may be used.

Updating the region-specific correction map is performed by newly setting regions for the imaging range of the imaging unit 130 and newly setting correction information in each of the regions.

First, the image analyzer 112b sets regions for the imaging range of the imaging unit 130 based on at least one frame of original image data and at least one frame of added image data. The imaging range of the imaging unit 130 corresponds to the range of an image expressed by the each frame of image data output from the imaging unit 130.

Setting of the regions is performed by, for example, applying an image recognition technology to the original image data and added image data so as to specify a subject imprinted in the image corresponding to the image data (original image data or added image data) and to obtain position information of a region occupied by each of the specified subjects on the image corresponding to the image data.

Specifying of the subject may be performed according to, for example, at least one of color information, contrast information, and gradation information in a large number of minute regions set for the original image data and the added image data. The position information of each region occupied by each subject may be composed of, for example, coordinate information of pixels defining a boundary of the region on an image corresponding to the image data. Alternatively, the position information of each region may be composed of coordinate information of pixels belonging to the region.

Next, the image analyzer 112b refers to the subject classification database 156 recorded in the recording unit 150 to acquire appropriate correction information on each of the specified subjects. As a result, correction information on each region corresponding to each subject is obtained.

Subsequently, the image analyzer 112b rewrites the position information of the regions and the correction information of the pixels belonging to each of the regions, based on the position information and the correction information on the regions obtained in this way. In other words, the image analyzer 112b rewrites the correction information on each pixel in an image corresponding to the each frame of image data output from the imaging unit 130.

With this configuration, the region-specific correction map having the correction information on each of the regions set for the imaging range is updated.

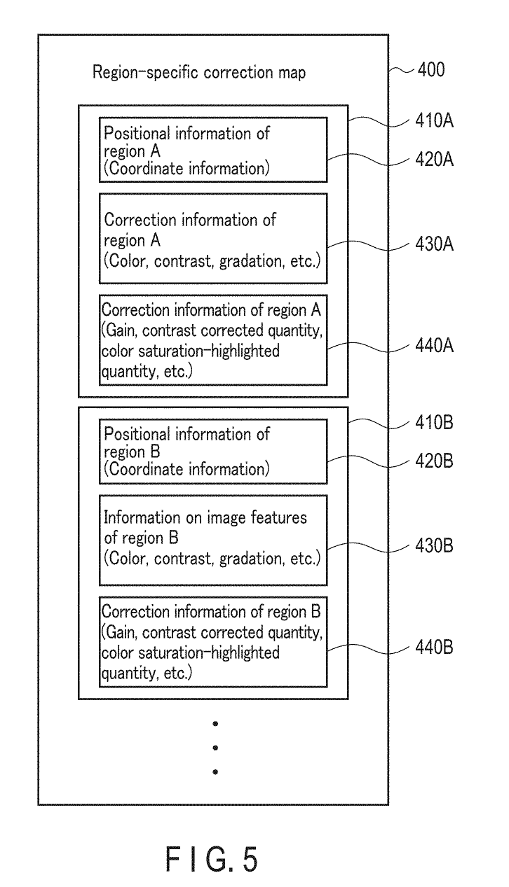

FIG. 5 schematically shows the structure of the region-specific correction map 400. As shown in FIG. 5, the region-specific correction map 400 has region-specific information 410A, 410B, . . . associated with regions A, B, . . . set for the imaging range.

The region-specific information 410A, 410B, . . . respectively include position information 420A, 420B, . . . of regions A, B, . . . , image characteristic information 430A, 430B, . . . of the regions A, B, . . . , and correction information 440A, 440B, . . . of the regions A, B, . . . .

For example, the position information 420A, 420B, is composed of coordinate information of pixels defining a boundary between the regions A, B, . . . on an image corresponding to the each frame of image data output from the imaging unit 130, or coordinate information of pixels belonging to the regions A, B, . . . .

The image characteristic information 430A, 430B, . . . includes information, for example, color, contrast, gradation, and the like.

The correction information 440A, 440B, . . . includes information, for example, gain, contrast correction quantity, saturation enhancement quantity, and the like.

<Recording Image Data Generator 112d>

The recording image data generator 112d generates recording image data that has been corrected based on the region-specific correction map for one frame of image data acquired by the image acquisition unit 112a. With this approach, it is also possible to record the entire image as a well-defined good-looking image, not in a uniform representation, although it is a captured image of a decisive moment.

At this time, it is easier to understand to describe that image data is recorded, but image data can also be used for observation purposes such as a case where image data is recorded, displayed and then disappears. When a correction is performed on an image of one frame, not simply only a “correction”, but also other different information may be given to a specific region of the image. For example, in a pattern of a dark place that cannot be seen even if it is corrected many times, a method can be adopted in which only a relevant portion is brought from a previously obtained image and subjected to a synthesis.

The recording image data generator 112d also generates an image file to be recorded in the recording unit 150 and outputs it to the recording unit 150. The image file includes not only recording image data, but also various accompanying information, etc. The recording image data generator 112d generates a still image file for still image photographing and a moving image file for moving image photographing.

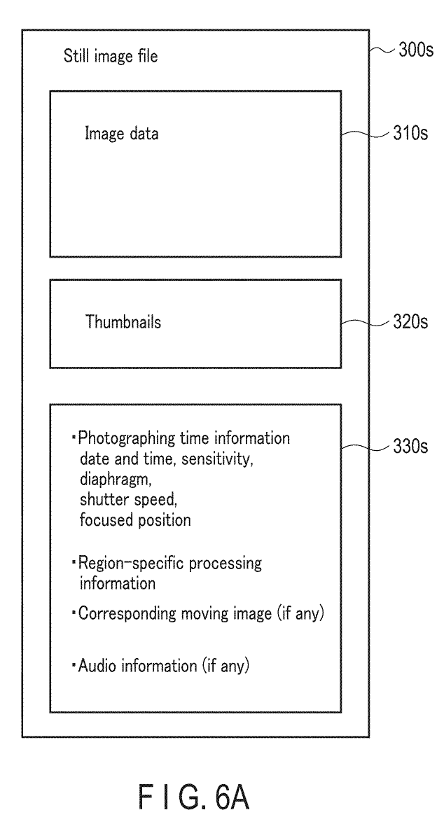

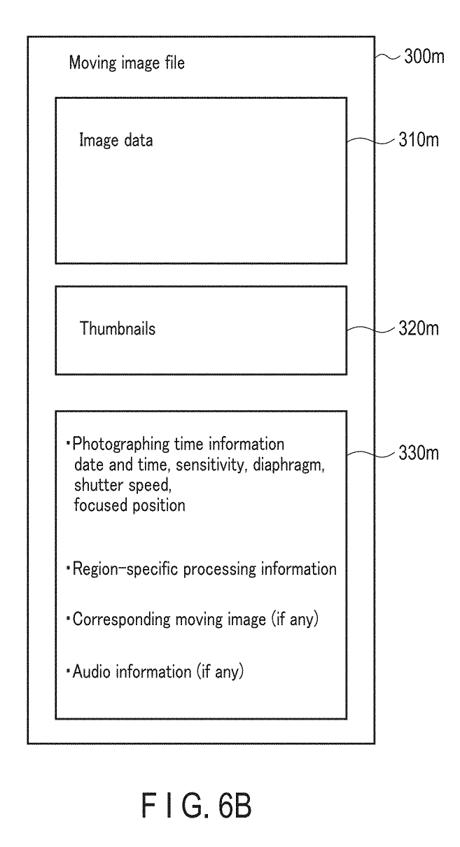

FIG. 6A schematically shows the structure of a still image file 300s generated by the recording image data generator 112d. As shown in FIG. 6A, the still image file 300s includes image data 310s, thumbnails 320s, and accompanying information 330s.

The image data 310s of the still image file 300s is composed of one frame of recording image data.

The thumbnails 320s are composed of, for example, reduced image data of one frame of recording image data, which is image data 310s.

The accompanying information 330s includes photographing time information. The photographing time information includes information such as date and time, sensitivity, shutter speed, aperture, focus position, and the like.

The accompanying information 330s also includes region-specific processing content. The region-specific processing content represents content of image processing applied to regions of the imaging range when generating one frame of recording image data, which is the image data 310s, and includes information of the region-specific correction maps, for example, position information of regions, correction information used for each region, etc.

In the case where a still image is generated during moving image photographing, the accompanying information 330s may include information on a moving image corresponding to the still image.

Furthermore, for example, when there is sound information acquired through a microphone mounted on the imaging unit 130, the accompanying information 330s may include the sound information.

FIG. 6B schematically shows the structure of the moving image file 300m generated by the recording image data generator 112d. As shown in FIG. 6B, the moving image file 300m includes image data 310m, thumbnails 320m, and accompanying information 330m.

The image data 310m of the moving image file 300m is composed of temporally continuous frames of recording image data.

The thumbnail 320m is composed of reduced image data of, for example, the first frame in the frames of recording image data included in the image data 310m.

The accompanying information 330m includes photographing time information. The photographing time information includes information such as date and time, sensitivity, frame rate, aperture, focus position, etc.

The accompanying information 330m also includes region-specific processing content. The region-specific processing content represents content of image processing applied to regions of the imaging range when generating the each frame of recording image data included in the image data 310m, and includes information of region-specific correction map for each frame of image data, for example, position information of regions, correction information applied to each region, and the like.

In the case where a still image is recorded during moving image photographing, the accompanying information 330m may include still image information corresponding to the moving image.

Furthermore, if there is sound information acquired through a microphone mounted on the imaging unit 130, for example, the accompanying information may include the sound information.

<Controller 114>

The controller 114 may be composed of, for example, a control circuit such as a CPU or an ASIC. The function equivalent to that of the controller 114 may be fabricated by software, or may be fabricated by a combination of hardware and software. In addition, some functions of the controller 114 may be fabricated by elements provided separately from the controller 114.

In addition to controlling the data processor 112, the controller 114 also controls the imaging unit 130, the display 140, the recording unit 150, and the operation device 160, in communication with the image processing apparatus 110. That is, the controller 114 totally controls the operation of the imaging system 100.

Hereinafter, some of the control performed by the controller 114 will be described; however, the control performed by the controller 114 is not limited to the control disclosed herein. Of course, the controller 114 may perform control not described below.

The controller 114 causes the imaging unit 130 to sequentially output image data through the data processor 112. The controller 114 causes the data processor 112 to sequentially acquire the image data from the imaging unit 130. The controller 114 causes the data processor 112 to visualize the acquired image data to sequentially output it in the display 140. At that time, the controller 114 further causes the display 140 to sequentially display the image data that is sequentially input through the data processor 112.

The controller 114 causes the data processor 112 to perform image processing to the acquired image data. At that time, the controller 114 acquires various kinds of information from various sensors 116 and provides the acquired various kinds of information to the data processor 112, thereby causing the data processor 112 to perform appropriate image processing. For example, the controller 114 causes the data processor 112 to generate a focus control signal based on the result of image processing, and to output the focus control signal to the imaging unit 130.

The controller 114 causes the recording image data generator 112d to generate recording image data in accordance with the operation of the operation device 160 by the user instructing the recording of the image or in accordance with a specific condition. Hereinafter, the control performed by the controller 114 will be described separately for each of the case of still image recording and the case of moving image recording.

(Still Image Recording)

If instructions to record an image are instructions to photograph a still image, the controller 114 causes the recording image data generator 112d to generate one frame of recording image data. Thereafter, the controller 114 causes the recording image data generator 112d to generate a still image file including the generated frame of recording image data.

At that time, the controller 114 causes the recording image data generator 112d to include photographing time information in the still image file. As described above, the photographing time information includes information such as date and time, sensitivity, shutter speed, aperture, focus position, etc. For example, the controller 114 obtains date and time information from the clock 118 in accordance with the operation of the operation device 160 by the user instructing the recording of the image, and provides the acquired date and time information to the recording image data generator 112d, thereby causing the recording image data generator 112d to include the date and time information in the still image file. With this configuration, it is clarified at what time the picture was taken, and evidentiality, etc. will be enhanced. Furthermore, according to the present invention, since a good image can be obtained by one photographing, its accuracy is also high.

The controller 114 further causes the recording image data generator 112d to include region-specific processing content (information of region-specific correction map used to generate image data for recording of one frame) in the still image file.

Subsequently, the controller 114 causes the recording image data generator 112d to output the generated still image file to the recording unit 150. The controller 114 causes the recording unit 150 to record the input still image file in a still image recorder 152 through the data processor 112.

(Moving Image Recording)

In the case where image recording instructions are instructions to start moving image photographing, the controller 114 causes the recording image data generator 112d to sequentially generate recording image data. Thereafter, the controller 114 causes the recording image data generator 112d to end the generation of the recording image data in response to the operation of the operation device 160 by the user instructing the end of the moving image photographing, and subsequently, to generate a moving image file including generated temporally continuous frames of recording image data.

At that time, the controller 114 causes the recording image data generator 112d to include photographing time information in the moving image file. For example, the controller 114 acquires date and time information as photographing start date and time information from the clock 118 in response to the operation of the operation device 160 by the user instructing the recording of the image, and also acquires date and time information as photographing end date and time information from the clock 118 in response to the operation of the operation device 160 by the user instructing the end of the image recording, and provides the acquired photographing start date and time information and photographing end date and time information to the recording image data generator 112d, thereby causing the recording image data generator 112d to include the photographing start date and time information and photographing end date and time information in the moving image file.

The controller 114 causes the recording image data generator 112d to include region-specific processing content (information of the region-specific correction map used for generation of image data for recording of one frame) in the moving image file.

Subsequently, the controller 114 causes the recording image data generator 112d to output the generated moving image file to the recording unit 150. The controller 114 causes the recording unit 150 to record the input moving image file in the moving image recorder 154 through the data processor 112.

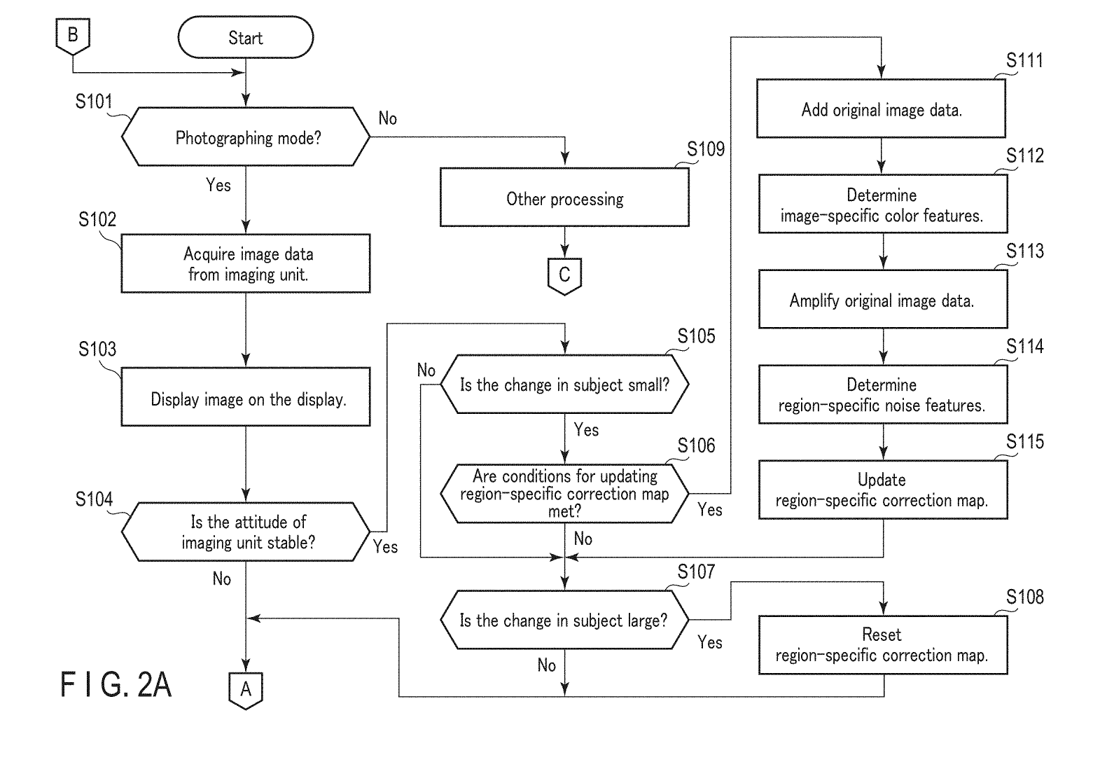

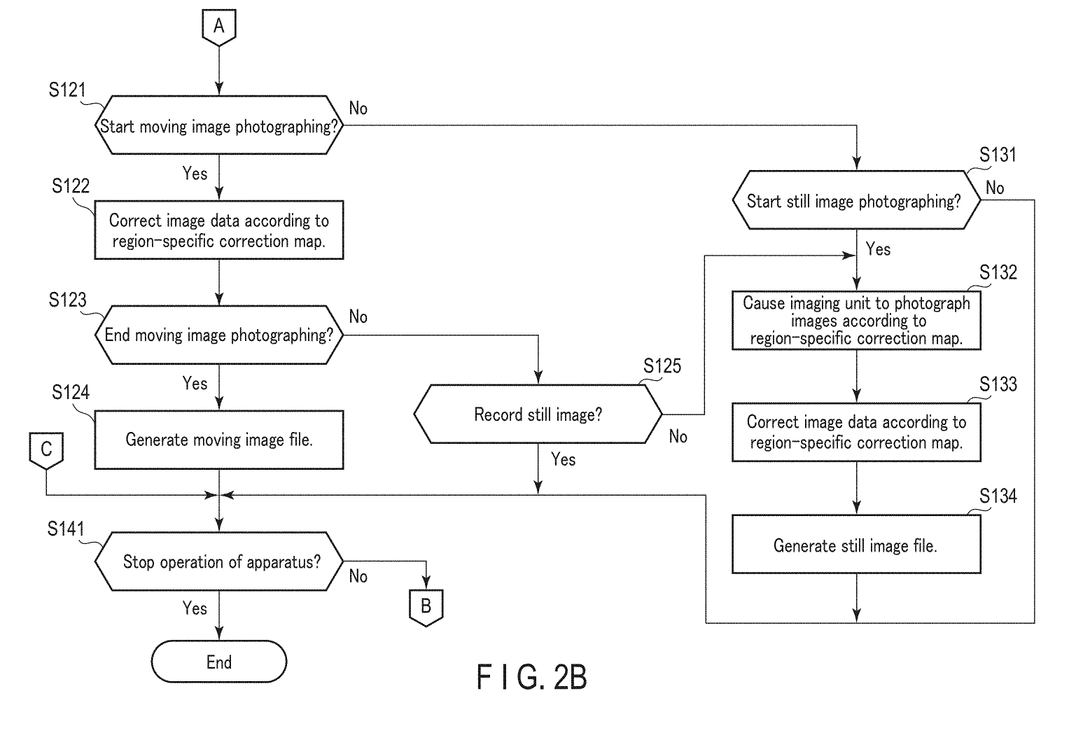

Next, the operation of the image processing apparatus 110 according to the present embodiment will be described. FIG. 2A and FIG. 2B show flowcharts of the photographing process in the imaging system 100 including the image processing apparatus 110 according to the present embodiment. The process in FIGS. 2A and 2B is performed mainly by the controller 114.

The flowcharts shown in 2A and 2B illustrate the operation of the image processing apparatus 110 during a time from a standby state of waiting for start-up until the image processing apparatus 110 is stopped and returns to the standby state. In the following description, it is assumed that the imaging unit 130, the display 140, the recording unit 150, and the operation device 160 are all started up during the processing of FIG. 2A and FIG. 2B.

In the standby state, when a start/stop button of the operation device 160 is pressed by the user, the controller 114 determines that start-up of the image processing apparatus 110 has been instructed, and starts up the image processing apparatus 110.

After the image processing apparatus 110 is started up, in step S101, the controller 114 determines whether or not the current operation mode of the imaging system 100 is a photographing mode. The controller 114 stores the operation mode of the imaging system 100 set by the operation of the operation device 160 by the user. The controller 114 determines whether or not the current operation mode is the photographing mode according to the stored operation mode. In step S101, if it is determined that the operation mode is the photographing mode, the process proceeds to step S102. Conversely, if it is determined in step S101 that the operation mode of the imaging system 100 is not the photographing mode, the process proceeds to step S109.

In step S109, the controller 114 performs other processes other than the photographing mode. After the other process is performed, the process proceeds to step S141.

The other processes include, for example, the process in a playback mode. In this case, the controller 114 determines whether or not the current operation mode is the playback mode. If it is determined that the operation mode is not the playback mode, the process proceeds to step S141. If it is determined that the operation mode is the playback mode, the controller 114 causes the imaging system 100 to perform playback processing. Thereafter, the process proceeds to step S141.

In step S102, the controller 114 causes the image acquisition unit 112a of the data processor 112 to acquire image data from the imaging unit 130. Thereafter, the process proceeds to step S103.

In step S103, the controller 114 causes the data processor 112 to output the acquired image data to the display 140. The controller 114 further causes the display 140 to display an image corresponding to the image data to be input through the data processor 112. Thereafter, the process proceeds to step S104.

While the operation mode is the photographing mode, the processing of step S102 and the processing of step S103 are repeated. In other words, while the operation mode is the photographing mode, loop processing including the process of step S102 and the process of step S103 is performed. As a result, image data output from the imaging unit 130 is sequentially displayed on the display 140. Namely, a live view is displayed on the display 140.

In step S104, the controller 114 causes the data processor 112 to determine whether or not the attitude of the imaging unit 130 is stable. For example, although not shown in FIG. 1, an attitude detection sensor, e.g., a gyro sensor is mounted on the imaging unit 130, and the data processor 112 determines, based on an output signal of the attitude detection sensor, whether or not the attitude of the imaging unit 130 is stable. If it is determined in step S104 that the attitude of the imaging unit 130 is stable, the process proceeds to step S105. Conversely, if it is determined in step S104 that the attitude of the imaging unit 130 is not stable, the process proceeds to step S121.

In step S105, the controller 114 causes the data processor 112 to determine whether or not the change in the subject is small. For example, the data processor 112 compares the one frame of image data acquired in step S102 in the current loop processing and the one frame of image data acquired in step S102 in the previous loop processing to determine whether or not the change in the subject is small, based on the comparison result. For example, the data processor 112 performs correlation analysis on such image data of two temporally continuous frames. Subsequently, the data processor 112 compares a correlation value obtained by the correlation analysis with a preset threshold value, and if the correlation value is equal to or greater than the threshold value, it determines that the change in the subject is small, and conversely, if the correlation value is less than the threshold value, it determines that the change in the subject is not small. In step S105, if it is determined that the change in the subject is small, the process proceeds to step S106. Conversely, if it is determined in step S105 that the change in the subject is not small, the process proceeds to step S107.

In step S106, the controller 114 causes the data processor 112 to determine whether or not the current situation meets the conditions for updating the region-specific correction map. As described above, the region-specific correction map is updated based on frames of image data. One of the conditions for updating the region-specific correction map is that a predetermined fixed number of frames of image data necessary for updating the region-specific correction map are accumulated in the image analyzer 112b. For example, if the predetermined fixed number of frames of image data are accumulated, the data processor 112 determines that the current situation meets the updating conditions. Conversely, if the predetermined fixed number of frames of image data are not accumulated, the data processor 112 determines that the current situation does not meet the update conditions. In step S106, if it is determined that the current situation meets the conditions for updating the region-specific correction map, the process proceeds to step S111. Conversely, if it is determined in step S106 that the current situation does not meet the conditions for updating the region-specific correction map, the process proceeds to step S107.

In step S111, the controller 114 causes the adder 112c of the image analyzer 112b to perform addition processing of frames of image data accumulated by the image analyzer 112b for updating the region-specific correction map. As described above, image data to be subjected to the addition processing is referred to as original image data, and image data obtained by the addition processing is referred to as added image data. In added image data, components attributable to a subject are increased, and components attributable to noise are reduced as compared to the original image data. Thereafter, the process proceeds to step S112.

In step S112, the controller 114 causes the image analyzer 112b to determine region-specific color features. For example, the image analyzer 112b performs color determination for each of a large number of minute regions set for each of image data, and classifies the minute regions according to the determination result. At that time, information obtained by comparing the original image data and the added image data may be used. Thereafter, the process proceeds to step S113.

In step S113, the controller 114 causes the image analyzer 112b to amplify the original image data. In the following description, amplified original image data is referred to as amplified image data. In the amplified image data, components attributable to a subject as well as components attributable to noise are increased as compared to the original image data. Thereafter, the process proceeds to step S114.

In step S114, the controller 114 causes the image analyzer 112b to determine region-specific noise features. By comparing the added image data with the amplified image data, for example, for each of a large number of minute regions set for each of the image data, the image analyzer 112b determines whether or not the data of the pixels belonging to the minute region is mainly attributable to the subject or is mainly attributable to noise, and then classifies the data into each minute region according to the determined result. For example, when the data of the pixels belonging to the minute region greatly differs between the added image data and the amplified image data, the image analyzer 112b determines that the data of those pixels is mainly attributable to noise. Conversely, when the data of the pixels belonging to the minute region does not greatly differ therebetween, the data of these pixels is determined to be mainly attributable to the subject. Thereafter, the process proceeds to step S115.

In step S115, the controller 114 causes the image analyzer 112b to update the region-specific correction map. The image analyzer 112b newly sets regions for the imaging range of the imaging unit 130 and newly sets correction information in each of these regions, thereby updating the region-specific correction map. The region-specific correction map is updated, for example, in the following manner.

First, the image analyzer 112b specifies a subject imprinted in an image corresponding to original image data by the image recognition technology for the original image data and the added image data. Next, the image analyzer 112b obtains position information of a region occupied by each of the identified subjects on the image corresponding to the original image data. With this, according to the specified subject, regions set for the imaging range of the imaging unit 130 corresponding to the image corresponding to the original image data are specified.

Next, the image analyzer 112b refers to the subject classification database 156 recorded in the recording unit 150 to obtain appropriate correction information on each of the specified subjects. With this, correction information on each region corresponding to each subject is obtained.

Subsequently, based on the position information and the correction information on the regions obtained in this way, the image analyzer 112b rewrites region-specific information of the region-specific correction map, i.e., position information of the regions, the image characteristic information of the regions, and correction information of the regions.

As a result, the region-specific correction map having the correction information on each of the regions set for the imaging range according to the subject is updated. Thereafter, the process proceeds to step S107.

In step S107, the controller 114 causes the data processor 112 to determine whether or not the change in the subject is large. For example, the data processor 112 compares the one frame of image data acquired in step S102 in the current loop processing and the one frame of image data acquired in step S102 in the previous loop processing to determine whether or not the change in the subject is large, based on the comparison result. This determination is made, for example, by the same processing as in step S105. In step S107, if it is determined that the change in the subject is large, the process proceeds to step S108. Conversely, if it is determined in step S107 that the change in the subject is not large, the process proceeds to step S121.

In step S108, the controller 114 causes the image analyzer 112b to reset the region-specific correction map. The image analyzer 112b erases all region-specific information of the region-specific correction map. Along with this, the image analyzer 112b discards all the frames of image data temporarily accumulated for updating the region-specific correction map. Thereafter, the process proceeds to step S121.

In step S121, the controller 114 determines whether or not the start of moving image photographing has been instructed. For example, when the moving image button of the operation device 160 is pressed by the user, the controller 114 determines that the start of moving image photographing has been instructed. In step S121, if it is determined that the start of moving image photographing has been instructed, the process proceeds to step S122. If it is determined in step S121 that the start of moving image photographing is not instructed, the process proceeds to step S131.

In step S122, the controller 114 causes the recording image data generator 112d to generate recording image data. The recording image data generator 112d reads out the region-specific correction map from the image analyzer 112b and generates recording image data in which the one frame of original image data acquired in step S102 has been corrected in accordance with the region-specific correction map. The recording image data generator 112d sequentially accumulates recording image data generated in each loop processing until the end of moving image photographing is instructed. Thereafter, the process proceeds to step S123.

In step S123, the controller 114 determines whether or not the end of moving image photographing has been instructed. For example, when the moving image button of the operation device 160 is pressed again by the user, the controller 114 determines that the end of moving image photographing has been instructed. In step S123, if it is determined that the end of moving image photographing has been instructed, the process proceeds to step S124. Conversely, if it is determined in step S123 that the end of moving image photographing is not instructed, the process proceeds to step S125.

In step S124, the controller 114 causes the recording image data generator 112d to generate a moving image file. As described with reference to FIG. 6A, a moving image file includes image data, thumbnails, and accompanying information. Image data is composed of temporally continuous frames of recording image data accumulated in the recording image data generator 112d in step S122 until the end of moving image photographing is instructed. The controller 114 also causes the recording image data generator 112d to output the generated moving image file to the recording unit 150. The controller 114 causes the recording unit 150 to record the input moving image file in the moving image recorder 154 through the data processor 112. Thereafter, the process proceeds to step S141.

In step S125, the controller 114 determines whether or not still image photographing has been instructed. For example, when a release button of the operation device 160 is pressed by the user, the controller 114 determines that still image photographing has been instructed. In step S125, if it is determined that still image photographing has been instructed, the process proceeds to step S132. In step S125, if it is determined that still image photographing is not instructed, the process proceeds to step S141.

As described above, if it is determined in step S121 that the start of moving image photographing is not instructed, the process proceeds to step S131. In step S131, the controller 114 determines whether or not still image photographing has been instructed. This determination is made, for example, by the same processing as in step S125. In step S131, if it is determined that the still image photographing has been instructed, the process proceeds to step S132. In step S131, if it is determined that still image photographing is not instructed, the process proceeds to step S141.

In step S132, the controller 114 causes the imaging unit 130 to take pictures according to the region-specific correction map through the data processor 112. Therefore, the controller 114 causes the image analyzer 112b to calculate an optimum photographic condition, for example, an optimum exposure condition, etc. according to the region-specific correction map, and to output information of the optimum photographic condition to a photographic condition modification unit 134 of the imaging unit 130. The photographic condition modification unit 134 modifies photographic conditions, for example, exposure, of the imager 132 according to information of the input photographic condition. As a result, the imaging unit 130 outputs image data in photographing under the optimum photographic condition according to the region-specific correction map. Furthermore, the controller 114 causes the image acquisition unit 112a of the data processor 112 to acquire the image data in the photographing under the optimum photographic conditions according to the region-specific correction map from the imaging unit 130. Thereafter, the process proceeds to step S133.

In step S133, the controller 114 causes the recording image data generator 112d to generate recording image data. The recording image data generator 112d reads out the region-specific correction map from the image analyzer 112b and generates recording image data in which the one frame of image data acquired in step S132 has been corrected according to the region-specific correction map. Thereafter, the process proceeds to step S134.

In step S134, the controller 114 causes the recording image data generator 112d to generate a still image file. As described with reference to FIG. 6A, the still image file includes image data, thumbnails, and accompanying information. In step S132, the image data is composed of one frame of recording image data generated by the recording image data generator 112d. The controller 114 also causes the recording image data generator 112d to output the generated still image file to the recording unit 150. The controller 114 causes the recording unit 150 to record the input still image file in a still image recorder 152 through the data processor 112. Thereafter, the process proceeds to step S141.

In step S141, the controller 114 determines whether or not the stop of the image processing apparatus 110 has been instructed. For example, when the start/stop button of the operation device 160 is pressed again by the user, the controller 114 determines that the stop of the image processing apparatus 110 has been instructed. In step S141, if it is determined that the stop of the image processing apparatus 110 is not instructed, the process returns to step S101. Conversely, if it is determined in step S141 that the stop of the image processing apparatus 110 has been instructed, the controller 114 stops the image processing apparatus 110, and the image processing apparatus 110 returns to the standby state again.

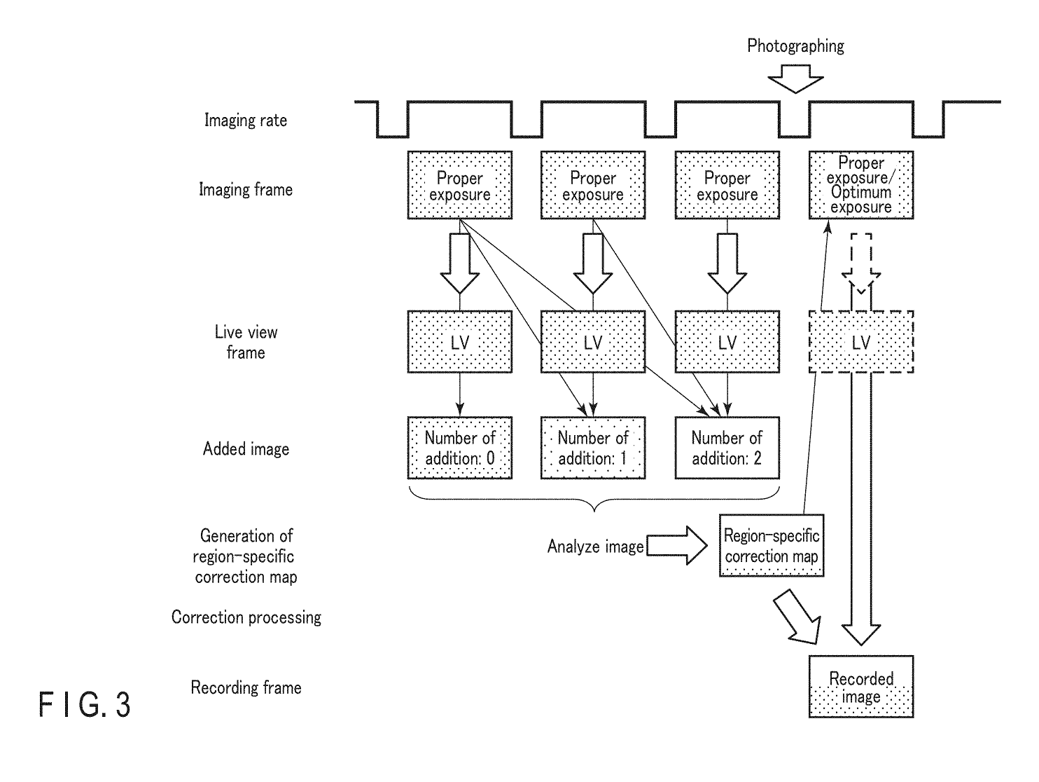

FIG. 3 is a timing chart showing the photographing operation performed in this way. FIG. 3 shows the actions before and after the start of moving image photographing as well as the actions before and after photographing a still image.

In FIG. 3, “imaging rate” indicates imaging timing. “Imaging frame” represents image data and exposure setting in each photographing. “Live view frame” represents an image displayed on the display 140.

“Added image” represents added image data having different addition numbers generated by addition processing by the adder 112c. In this embodiment, the addition number means the number of frames of the original image data used for addition processing. “Number of addition: 0” represents original image data to which addition processing has not been performed, “Number of addition: 1” represents added image data generated by addition processing of two frames of original image data, “Number of addition: 2” represents added image data generated by addition processing of three frames of original image data.

A “correction map” is stored in the image analyzer 112b, and represents the region-specific correction map, which is updated based on the original image data and the added image data. “Recording frame” represents image data corrected according to the region-specific correction map.

“Photographing” represents the timing at which the start of moving image photographing or still image photographing has been instructed. In both of the moving image photographing and the still image photographing, the image data of “imaging frame” is acquired by photographing with proper exposure until the instructions of “photographing”. The image data of “live view frame” is generated based on the image data of photographing with proper exposure.

When “photographing” indicates instructions to start moving image photographing, the image data of “imaging frame” is generated in photographing with proper exposure even after moving image photographing is started. Also, based on the image data, the image data of “live view frame” is generated. Furthermore, the image data is corrected according to the region-specific correction map, and the corrected image data of “recording frame” is generated.

On the other hand, when “photographing” indicates instructions for photographing a still image, the image data of “imaging frame” immediately after the instructions of still image photographing is generated in photographing with optimum exposure according to the region-specific correction map. Prior to the still image photographing, the generation of a live view frame is stopped. Therefore, the image data is not used for generating the image data of “live view frame”. Also, the image data is corrected according to the region-specific correction map, and the corrected image data of “recording frame” is generated.

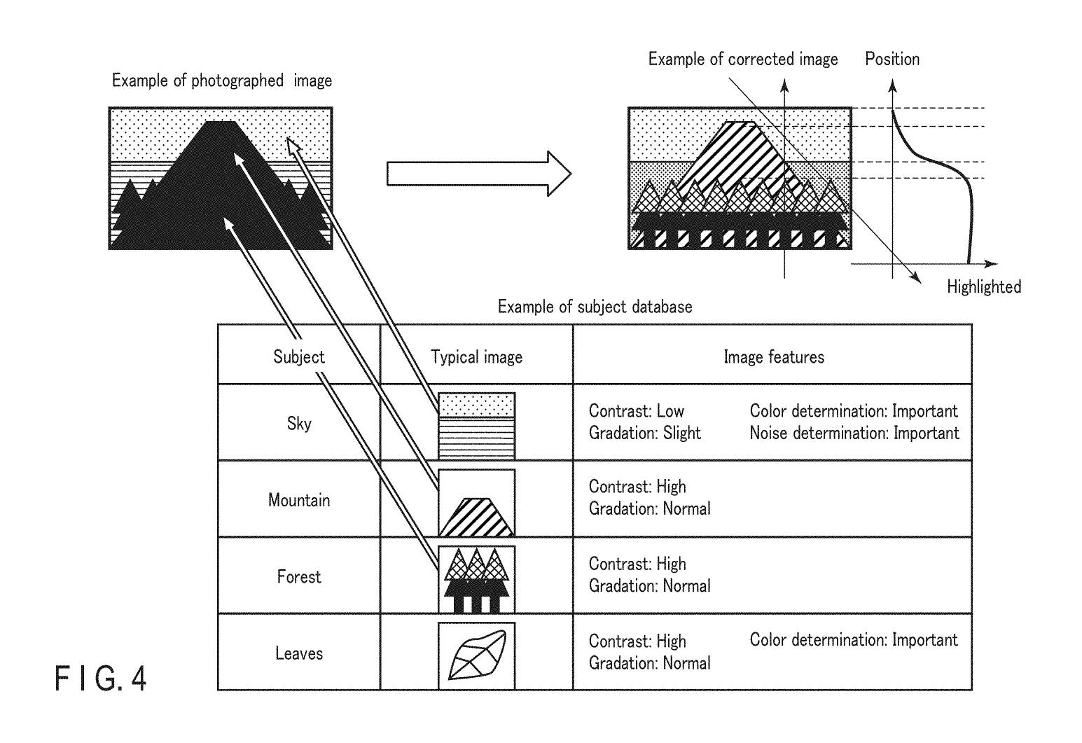

FIG. 4 illustrates a manner of image correction using the region-specific correction map. The photographed image example shown in FIG. 4 includes the subjects of a sky, a mountain, a forest, and leaves. In this photographed image example, since the image is taken so that the sky is properly exposed, the mountain, forest, and leaves have low brightness and are difficult to distinguish. For this photographed image example, subjects are specified for each minute region based on the image features of the minute region. As a result, finally, a region occupied by each subject of the sky, the mountain, the forest, and the leaves is obtained. Data of pixels belonging to each region obtained in this way is corrected according to appropriate correction information on the subject corresponding to each region. Thus, an example of a corrected image, in which data of pixels belonging to the regions of the subjects of the sky, the mountain, the forest, and the leaves has been properly corrected, can be obtained. In this example of the corrected image, the luminance of the data of the pixels belonging to the regions of the mountain, the forest, and the leaves is emphasized as compared with the data of the pixels belonging to the region belonging to the sky. As a result, in the corrected image example, the mountain, forest, and leaves, which are difficult to distinguish in the photographed image example, can be easily distinguished while keeping the exposure of the sky at the proper exposure.

As described above, according to the image processing apparatus of the present embodiment, a high-quality recorded image that has been appropriately corrected for each region occupied by each subject is formed. Moreover, the recorded image has a representation of, for example, a wide dynamic range; however, it is not formed on the basis of image data acquired at different times like an HDR image, but is acquired at an instant of time on the basis of one frame of image data. Therefore, a recorded image formed by the image processing apparatus according to the present embodiment is regarded as recorded information having no suspicion of having been falsified and having high credibility. By using image data with different addition numbers, it is possible to generate the region-specific correction map by using information that cannot be distinguished only with original image data. For example, in the original image data, a subject whose brightness is too low to be identified can be identified from added image data.

Each processing performed by the controller 114 according to the present embodiment can also be stored as a program that can be executed by a computer. The program can be stored in a recording medium of an external storage device such as a magnetic disk, an optical disk, a semiconductor memory, or the like, so as to be distributed. Then, the computer reads out the program stored in the recording medium of the external storage device, and by operating according to the read program, it is possible for the computer to execute the processing performed by the controller 114.

### Second Embodiment

Next, a second embodiment will be described with reference to the drawings. FIG. 7 is a block diagram showing the configuration of an imaging system including an image processing apparatus according to the second embodiment. In FIG. 7, members denoted by the same reference signs as those shown in FIG. 1 are similar members, and detailed descriptions thereof will be omitted. Hereinafter, an explanation will be given focusing on differences. That is, the parts not mentioned in the following description are the same as those in the first embodiment. In addition to FIG. 7, in the present application, FIGS. 1, 10, and 14 also show the block diagrams. The figures are specialized for explaining the respective embodiments. In the embodiments, the essential difference is small and information prior to photographing is used effectively.

As in the first embodiment, the present embodiment is intended to acquire a high-quality recorded image with high visibility at a certain momentary time.

In an image processing apparatus 110 of the present embodiment, a data processor 112 causes an imaging unit 130 to perform photographing while repeatedly modifying the photographic conditions under the appropriate predetermined rule and to sequentially output image data in photographing under each photographic condition. In other words, the data processor 112 causes a photographic condition modification unit 134 to modify the photographic condition of an imager 132 according to the imaging rate of an imaging element 132b.

An image acquisition unit 112a sequentially acquires image data from the imaging unit 130 in photographing under a photographic condition repeatedly modified according to the appropriate predetermined rule. The image acquisition unit 112a includes an HDR image data generating unit 112e configured to generate an HDR image based on image data in photographing under a series of photographic conditions, for example, exposure conditions. That is, since the photographic condition is modified, the live view image at this time has an effect of having a greater amount of information than in a general live view image. Only by that amount will the volume of data that can be referred to for correction will be increased. For example, there may be a case where the brighter information cannot be obtained only by addition of the first embodiment. Since this photographic condition change flickers as it is visualized, the generation of the HDR image data is carried out by performing synthesis processing to frames of image data in photographing under a series of photographic conditions, for example, exposure conditions. The HDR image data generated by such synthesis processing has a wide dynamic range.

In the present embodiment, the image data in photographing under a series of photographic conditions means the frames of image data corresponding to photographic conditions constituting one repeating unit in the modification of photographic conditions repeatedly performed. For example, when the modification of the photographic conditions is repeated under a first photographic condition and a second photographic condition, image data in the photographing under a series of photographic conditions is two frames of image data composed of one frame of image data in photographing under the first photographic condition and one frame of image data in photographing under the second photographic condition.

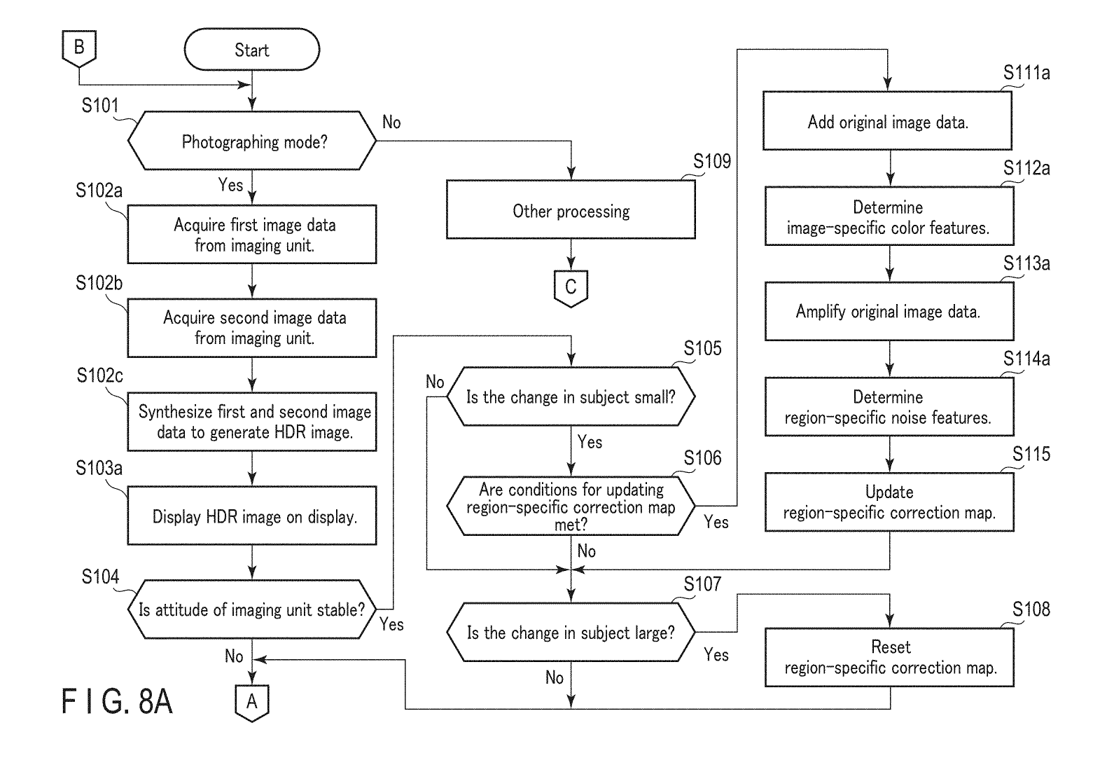

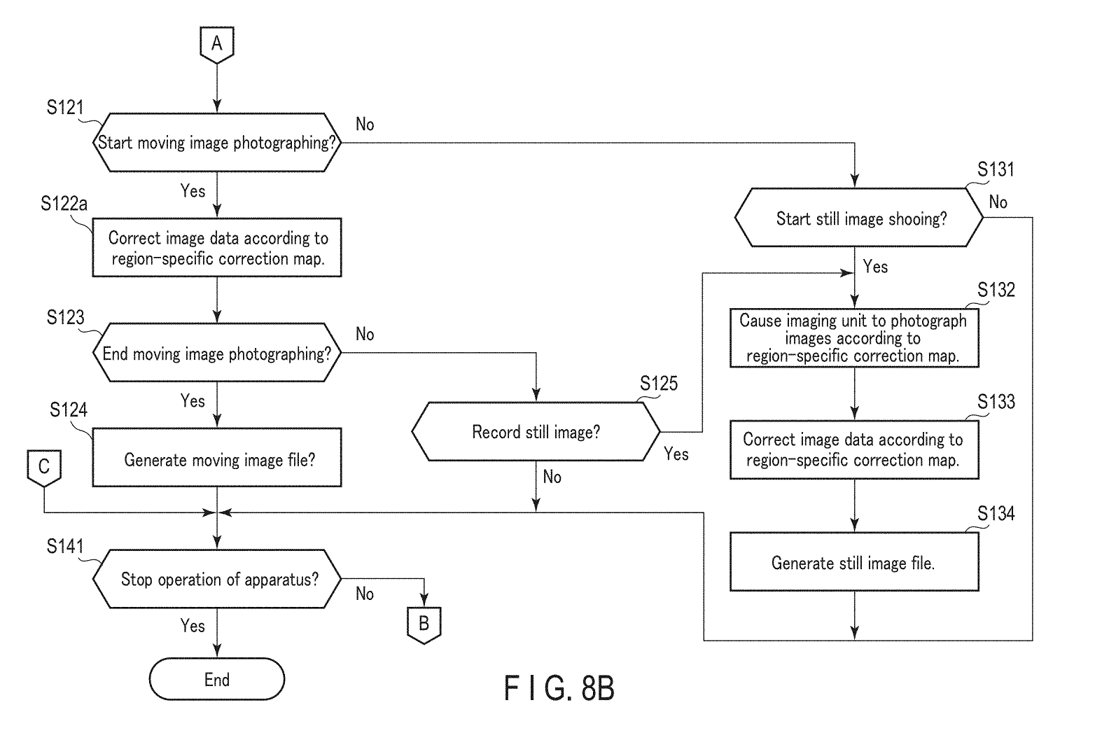

Next, the operation of the image processing apparatus 110 according to the present embodiment will be described. FIGS. 8A and 8B are flowcharts of the photographing process in the imaging system 100 including the image processing apparatus 110 according to the present embodiment. In FIGS. 8A and 8B, blocks denoted by the same reference signs as the blocks shown in FIGS. 2A and 2B represent the same processing, and detailed descriptions thereof will be omitted.

The flowcharts in FIGS. 8A and 8B illustrate the operation of the image processing apparatus 110 during a time from a standby state of waiting for start-up until the image processing apparatus 110 is stopped and returns to the standby state. In the following description, it is assumed that the imaging unit 130, a display 140, a recording unit 150, and an operation device 160 are all started up during the process of FIGS. 8A and 8B as in the description of the first embodiment.

In the standby state, when a start/stop button of the operation device 160 is pressed by the user, the controller 114 determines that start-up of the image processing apparatus 110 has been instructed, and starts up the image processing apparatus 110.

After the image processing apparatus 110 is started up, in step S101, the controller 114 determines whether or not the current operation mode of the imaging system 100 is a photographing mode. This determination is performed in the same manner as in the first embodiment. In step S101, if it is determined that the operation mode is the photographing mode, the process proceeds to step S102a. Conversely, if it is determined in step S101 that the operation mode of the imaging system 100 is not the photographing mode, the process proceeds to step S109.

In step S109, the controller 114 performs other processes other than the photographing mode. The other processes are as described in the first embodiment. After the other process is performed, the process proceeds to step S141.

In step S102a, the controller 114 causes an image acquisition unit 112a of the data processor 112 to cause the imaging unit 130 to perform photographing under the first photographic condition and to acquire, from the imaging unit 130, first image data in the photographing under the first photographic condition. In the present embodiment, the first photographic condition is a condition of exposure higher than the proper exposure. Therefore, the first image data is image data generated in photographing under the exposure condition higher than the proper exposure. In the following description, the first image data is also referred to as overexposed image data. Thereafter, the process proceeds to step S102b.

In step S102b, the controller 114 causes the image acquisition unit 112a of the data processor 112 to cause the imaging unit 130 to perform photographing under a second photographic condition and to acquire, from the imaging unit 130, second image data in the photographing under the second condition. In the present embodiment, the second photographic condition is a condition of exposure lower than the proper exposure. Therefore, the second image data is image data generated in photographing under the exposure condition lower than the proper exposure. In the following description, the second image data is also referred to as underexposed image data. Thereafter, the process proceeds to step S102c.

In step S102c, the controller 114 causes an HDR image data generator 112e to perform synthesis processing to the first image data and the second image data acquired by the image acquisition unit 112a to generate HDR image data. Thereafter, the process proceeds to step S103a.

In step S103a, the controller 114 causes the data processor 112 to output the HDR image data generated by the HDR image data generator 112e to the display 140. Furthermore, the controller 114 causes the display 140 to display an HDR image corresponding to the HDR image data to be input through the data processor 112. Thereafter, the process proceeds to step S104.

While the operation mode is the photographing mode, the processes of steps S102a to S102c and the process of step S103a are repeated. As a result, a live view of the HDR image is displayed on the display 140.

In step S104, the controller 114 causes the data processor 112 to determine whether or not the attitude of the imaging unit 130 is stable. This determination is performed in the same manner as in the first embodiment. If it is determined in step S104 that the attitude of the imaging unit 130 is stable, the process proceeds to step S105. Conversely, if it is determined in step S104 that the attitude of the imaging unit 130 is not stable, the process proceeds to step S121.

In step S105, the controller 114 causes the data processor 112 to determine whether or not the change in the subject is small. This determination is performed in the same manner as in the first embodiment. In step S105, if it is determined that the change in the subject is small, the process proceeds to step S106. Conversely, if it is determined in step S105 that the change in the subject is not small, the process proceeds to step S107.

In step S106, the controller 114 causes the data processor 112 to determine whether or not the current situation meets the conditions for updating the region-specific correction map. This determination is performed in the same manner as in the first embodiment. In step S106, if it is determined that the current situation meets the conditions for updating the region-specific correction map, the process proceeds to step S111a. Conversely, if it is determined in step S106 that the current situation does not meet the conditions for updating the region-specific correction map, the process proceeds to step S107.

In step S111a, the controller 114 causes the adder 112c of the image analyzer 112b to perform addition processing to the original image data. Original image data to be subjected to the addition processing is mainly the second image data, i.e., underexposed image data, and there is no need to perform the addition processing to the first image data, i.e., overexposed image data. This addition processing is not always required and may be omitted. Thereafter, the process proceeds to step S112a.

In step S112a, the controller 114 causes the image analyzer 112b to determine region-specific color features. For example, the image analyzer 112b performs color determination for each of a large number of minute regions set for each of image data, and classifies the minute regions according to the determination result. At that time, information obtained by comparing the original image data (the first image data and the second image data) may be used, and information obtained by comparing the original image data and the added image data may also be used. Thereafter, the process proceeds to step S113a.

In step S113a, the controller 114 causes the image analyzer 112b to amplify the original image data. In the following description, the amplified original image data is referred to as amplified image data. In the amplified image data, components attributable to a subject as well as components attributable to noise are increased as compared to the original image data. The original image data to be amplified is mainly the second image data, i.e., underexposed image data, and there is little need to perform the amplification processing to the first image data, i.e., overexposed image data. Thereafter, the process proceeds to step S114a.

In step S114a, the controller 114 causes the image analyzer 112b to determine region-specific noise features. The image analyzer 112b compares the original image data (the first image data and the second image data), the added image data (mainly, added second image data), and the amplified image data (i.e., amplified second image data) for, for example, each of a large number of minute regions set for each of image data to thereby determine whether data of the pixels belonging to a minute region is mainly attributable to the subject or mainly attributable to noise, and to classify each minute region according to the determination result. Thereafter, the process proceeds to step S115.

In step S115, the controller 114 causes the image analyzer 112b to update the region-specific correction map. The updating of the region-specific correction map is performed in the same way as in the first embodiment. Thereafter, the process proceeds to step S107.

In step S107, the controller 114 causes the data processor 112 to determine whether or not the change in the subject is large. This determination is performed in the same manner as in the first embodiment. In step S107, if it is determined that the change in the subject is large, the process proceeds to step S108. Conversely, if it is determined in step S107 that the change in the subject is not large, the process proceeds to step S121.

In step S108, the controller 114 causes the image analyzer 112b to reset the region-specific correction map. The image analyzer 112b erases all region-specific information of the region-specific correction map. Along with this, the image analyzer 112b discards all the frames of image data temporarily accumulated for updating the region-specific correction map. Thereafter, the process proceeds to step S121.

In step S121, the controller 114 determines whether or not the start of moving image photographing has been instructed. For example, when the moving image button of the operation device 160 is pressed by the user, the controller 114 determines that the start of moving image photographing has been instructed. In step S121, if it is determined that the start of moving image photographing has been instructed, the process proceeds to step S122a. In step S121, if it is determined that the start of moving image photographing is not instructed, the process proceeds to step S131.

In step S122a, the controller 114 causes the imaging unit 130 to photograph under an appropriate photographic condition, for example, a proper exposure condition, through the data processor 112. The photographing by the imaging unit 130 is performed in the same manner as in the first embodiment.

The controller 114 also causes the image analyzer 112b to update the region-specific correction map based on the image data generated by photographing under the proper exposure condition. The updating of the region-specific correction map is performed in the same manner as in the first embodiment.

The controller 114 also causes a recording image data generator 112d to generate recording image data and accumulated the generated recording image data. Recording image data is generated and accumulated in the same manner as in the first embodiment. Thereafter, the process proceeds to step S123.

In step S123, the controller 114 determines whether or not the end of moving image photographing has been instructed. For example, when the moving image button of the operation device 160 is pressed again by the user, the controller 114 determines that the end of moving image photographing has been instructed. In step S123, if it is determined that the end of moving image photographing has been instructed, the process proceeds to step S124. Conversely, if it is determined in step S123 that the end of moving image photographing is not instructed, the process proceeds to step S125.

In step S124, the controller 114 causes the recording image data generator 112d to generate a moving image file and causes a moving image recorder 154 to record the generated moving image file through the data processor 112. The generation and recording of the moving image file is performed in the same manner as in the first embodiment. Thereafter, the process proceeds to step S141.

In step S125, the controller 114 determines whether or not still image photographing has been instructed. For example, when a release button of the operation device 160 is pressed by the user, the controller 114 determines that still image photographing has been instructed. If it is determined in step S125 that still image photographing has been instructed, the process proceeds to step S132. In step S125, if it is determined that still image photographing is not instructed, the process proceeds to step S141.

As described above, if it is determined in step S121 that the start of moving image photographing is not instructed, the process proceeds to step S131. In step S131, the controller 114 determines whether or not still image photographing has been instructed. This determination is made, for example, by the same processing as in step S125. In step S131, if it is determined that the still image photographing has been instructed, the process proceeds to step S132. In step S131, if it is determined that the still image photographing is not instructed, the process proceeds to step S141.

In step S132, the controller 114 causes the imaging unit 130 to photograph according to the region-specific correction map through the data processor 112. The photographing according to the region-specific correction map is performed in the same manner as in the first embodiment. Furthermore, the controller 114 causes the image acquisition unit 112a to acquire, from the imaging unit 130, image data in the photographing under an optimum photographic condition according to the region-specific correction map. Thereafter, the process proceeds to step S133.

In step S133, the controller 114 causes the recording image data generator 112d to generate recording image data. The generation of recording image data is performed in the same manner as in the first embodiment. Thereafter, the process proceeds to step S134.

In step S134, the controller 114 causes the recording image data generator 112d to generate a still image file and causes a still image recorder 152 to record the generated still image file. The generation and recording of the still image file is performed in the same manner as in the first embodiment. Thereafter, the process proceeds to step S141.

In step S141, the controller 114 determines whether or not the stop of the image processing apparatus 110 has been instructed. For example, when the start/stop button of the operation device 160 is pressed again by the user, the controller 114 determines that the stop of the image processing apparatus 110 has been instructed. In step S141, if it is determined that the stop of the image processing apparatus 110 is not instructed, the process returns to step S101. Conversely, if it is determined in step S141 that the stop of the image processing apparatus 110 has been instructed, the controller 114 stops the image processing apparatus 110, and the image processing apparatus 110 returns to the standby state again.

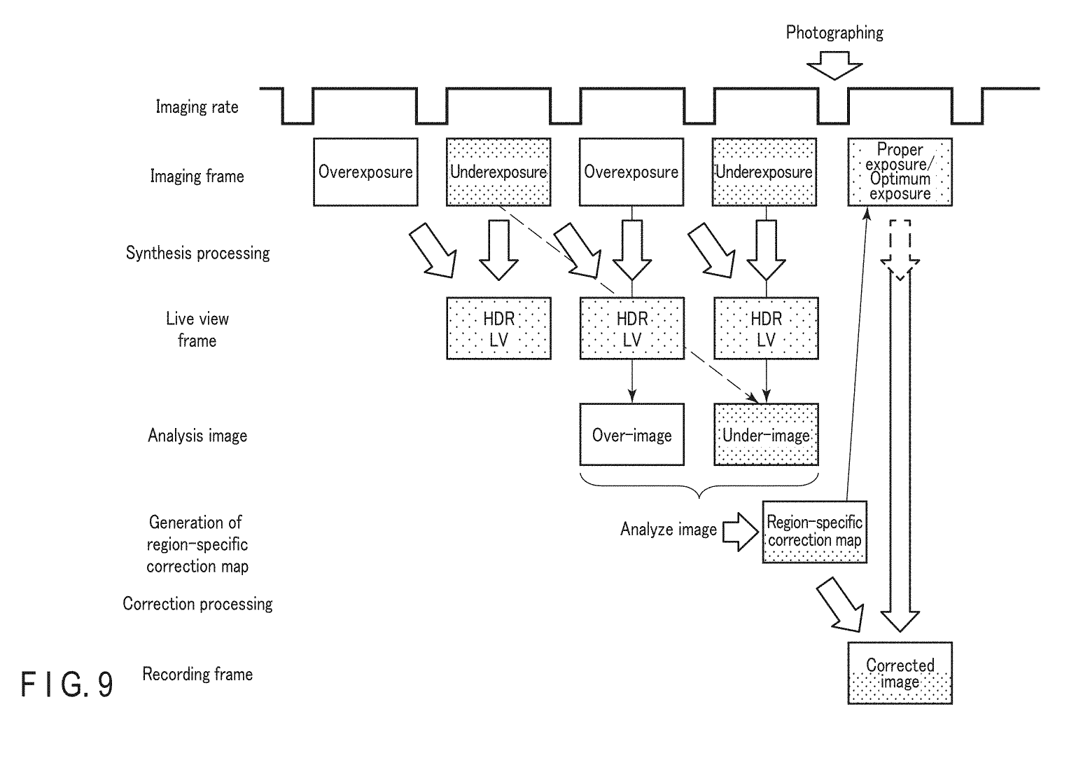

FIG. 9 is a timing chart showing the photographing operation performed in this way. FIG. 9 shows the operations before and after the start of moving image photographing as well as the operations before and after photographing still images.

In FIG. 9, “imaging rate” indicates imaging timing. “Imaging frame” represents image data and exposure setting in each photographing. Herein, “Overexposure” represents first image data, i.e., image data in photographing under a condition of exposure higher than the proper exposure, “Underexposure” represents second image data, i.e., image data in photographing under a condition of exposure lower than the proper exposure. “Live view frame” represents an HDR image displayed on the display 140.

“Analysis image” represents image data to be subjected to image analysis. “Over-image” represents “overexposed” image data or image data obtained by performing addition processing to the “overexposed” image data. “Under-image” represents “underexposed” image data or image data obtained by performing addition processing to the “underexposed” image data.

“Correction map” represents the region-specific correction map stored in the image analyzer 112b. “Recording frame” represents image data corrected according to the region-specific correction map.

“Photographing” represents the timing at which the start of moving image photographing or still image photographing has been instructed. In both of the moving image photographing and the still image photographing, until the instructions of “photographing” is made, “overexposed” image data of the “imaging frame” is composed of “overexposed” image data and “underexposed” image data that are alternately generated in photographing under an exposure condition that is alternately modified. The image data of “live view frame” is generated based on the “overexposed” image data and the “underexposed” image data.

When “photographing” indicates instructions to start moving image photographing, the image data of “Imaging frame” is generated in photographing with proper exposure after the start of moving image photographing. Based on the image data, the image data of “live view frame” is generated. Also, the image data is corrected according to the region-specific correction map, and the corrected image data of “recording frame” is generated.

In contrast, the image data of “imaging frame” immediately following instructions for still image photographing is generated in photographing with optimum exposure according to the region-specific correction map. Prior to the still image photographing, the generation of the live view frame is stopped. Therefore, the image data is not used for generating the image data of “live view frame”. Furthermore, the image data is corrected according to the region-specific correction map, and the corrected image data of “recording frame” is generated. In the present embodiment, the analysis result of the live view image is reflected because it is convenient for the reason that it is image information obtained at the timing prior to photographing, but of course, the way to reflect an analysis result is not limited thereto. An analysis result after photographing may be obtained and reflected in photographed images. The analysis result may be reflected before images are recorded or may be reflected when images are displayed after being subjected to image processing.

As described above, also in the image processing apparatus according to the present embodiment as well, and similar to the first embodiment, a high-quality recorded image that has been appropriately corrected for each region occupied by each subject is formed. Moreover, the recorded image is not formed on the basis of image data acquired at different times like the HDR image, but is formed on the basis of one frame of image data acquired at a certain instant of time. Therefore, the recorded image formed by the image processing apparatus according to the present embodiment is regarded as recorded information having no suspicion of having been falsified and having high credibility.

Each process performed by the controller 114 according to the present embodiment can also be stored as a program that can be executed by a computer as in the first embodiment.

### Third Embodiment

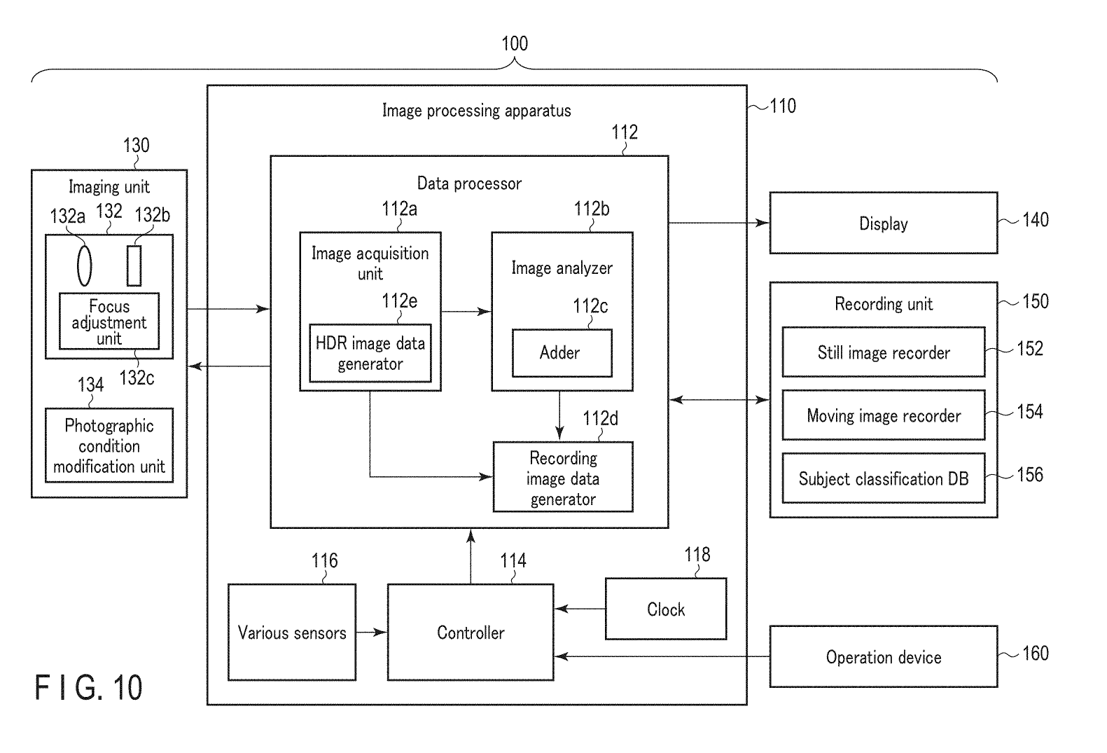

Next, a third embodiment will be described with reference to the drawings. FIG. 10 is a block diagram showing the configuration of an imaging system including an image processing apparatus according to the third embodiment. In FIG. 10, members denoted by the same reference signs as those shown in FIG. 1 are the same members, and detailed descriptions thereof will be omitted. Hereinafter, an explanation will be given focusing on differences. That is, the parts not mentioned in the following description are the same as those in the first embodiment. In addition to FIG. 10, in the present application, FIGS. 1, 7, and 14 also show the block diagrams. The figures are specialized for explaining the respective embodiments. In the embodiments, the essential difference is small and information prior to photographing is used effectively.

An HDR image is created by synthesizing temporally continuous frames of image data immediately after the timing of issuance of a photographing instruction. The frames of image data to be synthesized are those obtained in times of image data acquisition with different exposure conditions. The exposure condition is modified according to a predetermined rule. In order to obtain an appropriate image, it is desirable to utilize as much information as possible in order to determine exposure parameters and various parameters. The photographic parameters include exposure conditions (aperture, sensitivity, shutter speed, and exposure time, occasionally use of auxiliary light irradiation), focus conditions, zoom conditions, and the like.

The present embodiment is intended to obtain an optimum image corresponding to a subject in consideration of such a situation.

<Imaging Unit 130>

An imaging unit 130 includes a photographic condition modification unit 134 configured to modify the photographic condition of an imager 132 according to information of the photographic condition supplied from an image processing apparatus 110. The photographic condition modification unit 134 has a function of modifying the exposure, for example, by adjusting the aperture of an imaging optical system 132a or the exposure time of an imaging element 132b.

For example, in order to generate an HDR image, the photographic condition modification unit 134 repeatedly modifies the photographic conditions, for example, the exposure time of the imaging element 132b, under the appropriate predetermined rule. As a result, the imaging unit 130 sequentially outputs the image data of the image data acquisition while the photographic condition is repeatedly modified according to the appropriate predetermined rule.

<Data Processor 112>

The data processor 112 is configured to cause the imaging unit 130 to perform image data acquisition under specified photographic conditions and to output the image data. For example, to generate HDR image data, the data processor 112 causes the imaging unit 130 to perform image data acquisition while repeatedly modifying the photographic conditions, i.e., the exposure time of the imaging element 132b under the appropriate predetermined rule, and to sequentially output the image data in the image acquisition under each photographic condition.

The data processor 112 is configured to generate various kinds of information by performing image processing to image data acquired from the imaging unit 130. For example, the data processor 112 is configured to generate live view image data from the image data acquired from the imaging unit 130 and output the generated image data to the display 140. The data processor 112 is also configured to generate recording image data from the image data acquired from the imaging unit 130 and output the generated image data to a recording unit 150. The data processor 112 is also configured to generate a focus control signal by image processing and output the focus control signal to the imaging unit 130.

<Image Acquisition Unit 112a>

The image acquisition unit 112a sequentially acquires image data from the imaging unit 130. The image acquisition unit 112a can switch the mode of data reading at the time of still image photographing, at the time of moving image photographing, at the time of live view display, at the time of taking out a signal for autofocus, etc. The image acquisition unit 112a can also change the exposure time, etc., such as accumulation of optical signals, at the time of forming of imaging data (image data), and perform divisional readout of pixels, mixed readout, etc., as necessary. The image acquisition unit 112a can also sequentially acquire image data to cause the display 140 to display it without delay at the time of a live view used when the user confirms the object, etc. The image acquisition unit 112a sequentially acquires the image data thus subjected to the image processing, and sequentially outputs the acquired image data to the image analyzer 112b.

The image acquisition unit 112a sequentially acquires, from the imaging unit 130, image data in the image data acquisition while the photographic condition is repeatedly modified according to the appropriate predetermined rule. The image acquisition unit 112a also includes an HDR image data generating unit 112e configured to generate an HDR image based on image data in the image data acquisition under a series of photographic conditions, e.g., exposure conditions.

Since the HDR image is generated from the image data obtained in the image data acquisition while modifying the photographic condition, it contains more information than the ordinary image. That is, the HDR image contains much more data that can be used for correction. If the image data in the acquisition of the image data while modifying the photographic condition is visualized as it is, it becomes flickering, and thus the generation of the HDR image data is performed by performing synthesis processing to frames of image data in the image data acquisition under a series of photographic conditions, e.g., exposure conditions. An HDR image data generated by such synthesis processing has a wide dynamic range.

In order to generate HDR image data for live view, the data processor 112 causes the imaging unit 130 to perform image data acquisition while repeatedly modifying the photographic conditions according to the appropriate predetermined rule and to sequentially output the image data in the image data acquisition under each photographic condition. In other words, the data processor 112 causes the photographic condition modification unit 134 to modify the photographic conditions of the imager 132 in accordance with the imaging rate of the imaging element 132b.

The image acquisition unit 112a sequentially acquires, from the imaging unit 130, image data in the image data acquisition while the photographic condition is repeatedly modified according to the appropriate predetermined rule. The HDR image data generator 112e generates an HDR image by performing synthesis processing to frames of image data in the image data acquisition under a series of acquired photographic conditions, e.g., exposure conditions.

In the present embodiment, the image data in the image data acquisition under a series of photographic conditions means the frames of image data corresponding to photographic conditions constituting one repetition unit in the modification of the photographic conditions repeated according to the predetermined rule. For example, when the modification of the photographic conditions is repeated between the first photographic condition and the second photographic condition, the image data in the acquisition of the image data under the series of photographic conditions is two frames of image data composed of one frame of image data in the image data acquisition under the first photographic condition, and one frame of image data in the image data acquisition under the second photographic condition.

<Recording Image Data Generation Unit 112d>

The recording image data generator 112d generates recording at least one frame of image data based on image data acquired by the image acquisition unit 112a. For example, the recording image data generator 112d generates recording at least one frame of image data at the time of photographing a still image, and generates recording temporally continuous frames of image data during photographing a moving image.

During the photographing of a still image and during the photographing of a moving image, the data processor 112 causes the imaging unit 130 to perform image data acquisition while modifying the photographic condition based on the region-specific correction map and to sequentially output the image data in the image data acquisition under each photographic condition.

The recording image data generator 112d synthesizes frames of image data in the image data acquisition under different photographic conditions, which are obtained by the image acquisition unit 112a during such an image acquisition while image data acquisition while modifying the photographic condition based on the region-specific correction map, to generate one frame of recording image data.

The recording image data generator 112d also corrects the recording image data based on the region-specific correction map.

By the series of processes described above, it becomes also possible to obtain an optimum image corresponding to the subject.

At this time, it is easier to understand to describe that image data is recorded, but image data can also be used for observation purposes such as a case where image data is recorded, displayed, and then disappears. When a correction is performed on an image of one frame, not only simply a “correction”, but also other different information may be given to a specific region of the image. For example, in a pattern of a dark place that cannot be seen even if it is corrected many times, a method can be adopted in which only a relevant portion is brought from a previously obtained image and subjected to a synthesis.

The recording image data generator 112d also generates an image file to be recorded in the recording unit 150 and outputs it to the recording unit 150. The image file includes not only recording image data, but also various accompanying information, etc. The recording image data generator 112d generates a still image file for still image photographing and a moving image file for moving image photographing.

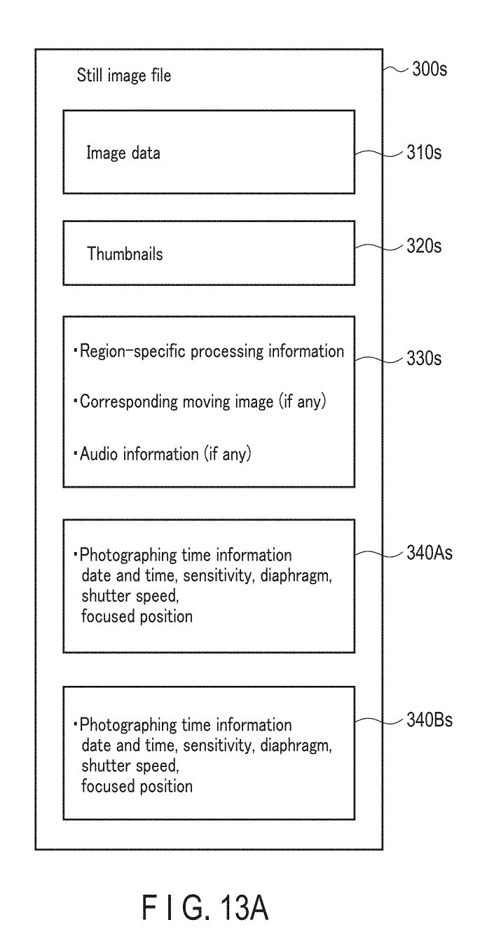

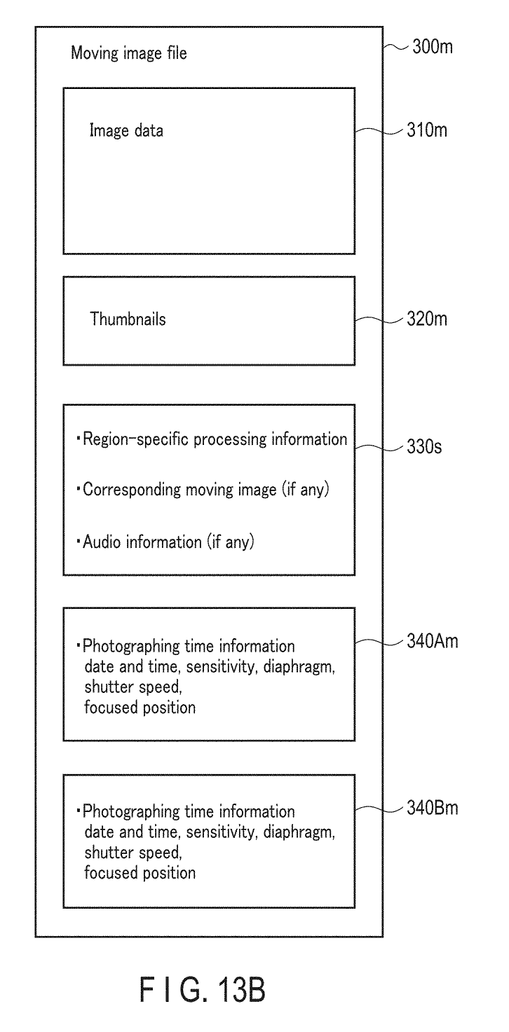

FIG. 13A schematically shows the structure of a still image file 300s generated by the recording image data generator 112d. As shown in FIG. 13A, the still image file 300s includes image data 310s, thumbnails 320s, accompanying information 330s, and image-specific synthesis source accompanying information 340As, 340Bs.

The image data 310s of the still image file 300s is composed of one frame of recording image data generated by synthesizing the frames of image data in the image data acquisition while modifying the photographic condition based on the region-specific correction map. In the example of FIG. 13A, the recording image data is generated by synthesizing two frames of image data. Of course, recording image data may be generated by synthesizing three or more frames of image data.

The thumbnails 320s are composed of, for example, reduced image data of one frame of recording image data, which is image data 310s.

The image-specific synthesis source accompanying information 340A and 340Bs includes photographing time information on the synthesis source images that have been synthesized in order to generate recording image data. The photographing time information includes information such as date and time, sensitivity, shutter speed, aperture, focus position, etc.

The accompanying information 330s includes region-specific processing content. The region-specific processing content represents content of image processing applied to regions of the imaging range when generating one frame of recording image data, which is the image data 310s, and includes information of the region-specific correction maps, for example, position information of regions, correction information used for each region, etc.

In the case where a still image is generated during moving image photographing, the accompanying information 330s may include information on a moving image corresponding to the still image.

Furthermore, for example, when there is sound information acquired through a microphone mounted on the imaging unit 130, the accompanying information 330s may include the sound information.

FIG. 13B schematically shows the structure of the moving image file 300m generated by the recording image data generator 112d. As shown in FIG. 13B, the moving image file 300m includes image data 310m, thumbnails 320m, accompanying information 330m, and image-specific synthesis source accompanying information 340Am and 340Bm.

The image data 310m of the moving image file 300m is composed of temporally continuous frames of recording image data. Each frame of recording image data is generated by synthesizing frames of image data in the image data acquisition while modifying the photographic condition based on the region-specific correction map. In the example of FIG. 13B, the each frame of recording image data is generated by synthesizing two frames of image data. Of course, the each frame of recording image data may be generated by synthesizing three or more frames of image data.

The thumbnail 320m is composed of reduced image data of, for example, the first frame in the frames of recording image data included in the image data 310m.

Synthesizing image-specific synthesis source accompanying information 340Am and 340Bm includes photographing time information on the synthesis source images that have been synthesized in order to generate each frame of recording image data. The photographing time information includes information such as date and time, sensitivity, frame rate, aperture, focus position, etc.

The accompanying information 330m includes region-specific processing content. The region-specific processing content represents content of image processing applied to regions of the imaging range when generating each frame of recording image data included in the image data 310m, and includes information of the region-specific correction map for each frame of image data, for example, position information of regions, correction information applied to each region, and the like.

In the case where a still image is recorded during moving image photographing, the accompanying information 330m may include still image information corresponding to the moving image.

Furthermore, if there is sound information acquired through a microphone mounted on the imaging unit 130, for example, the accompanying information 330m may include the sound information.

<Controller 114>

The controller 114 causes the imaging unit 130 to sequentially output image data through the data processor 112. The controller 114 causes the data processor 112 to sequentially acquire the image data from the imaging unit 130. The controller 114 also causes the data processor 112 to visualize HDR image data generated by the HDR image data generator 112e, and to sequentially output the HDR image data to the display 140. At that time, the controller 114 further causes the display 140 to sequentially display the entered HDR image data that is sequentially input through the data processor 112.

The controller 114 causes the data processor 112 to perform image processing to the acquired image data. At that time, the controller 114 acquires various kinds of information from various sensors 116 and provides the acquired various kinds of information to the data processor 112, thereby causing the data processor 112 to perform appropriate image processing. For example, the controller 114 causes the data processor 112 to generate a focus control signal based on the result of image processing, and to output the focus control signal to the imaging unit 130.

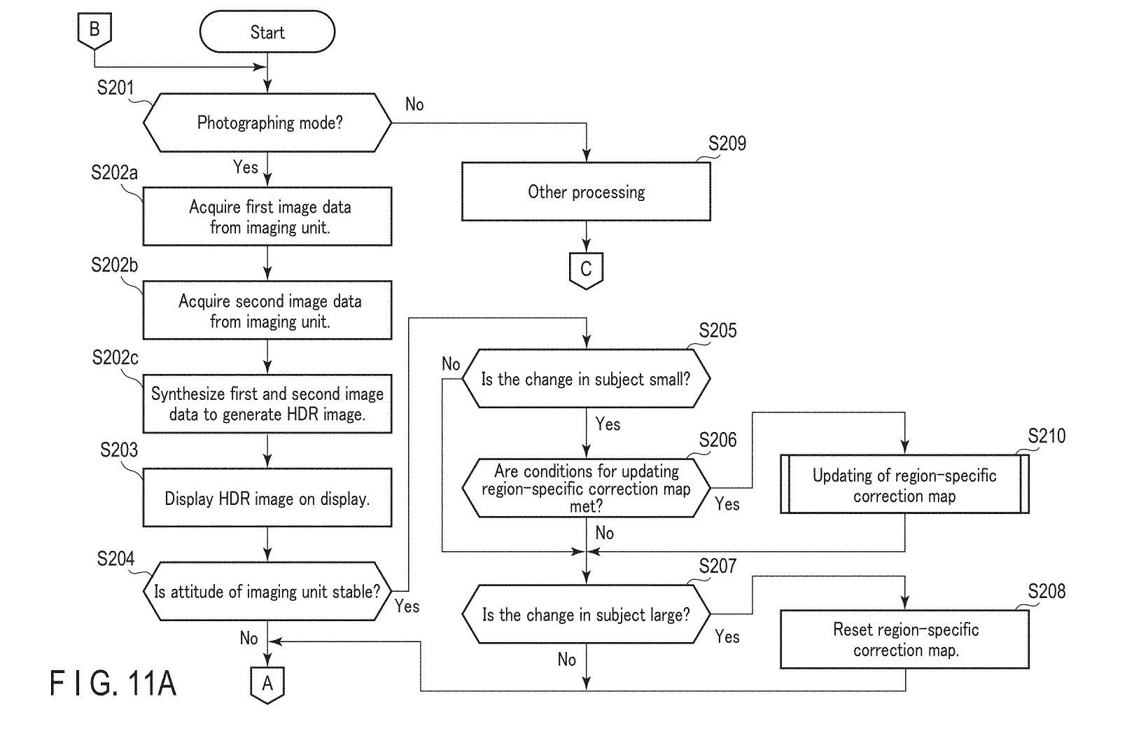

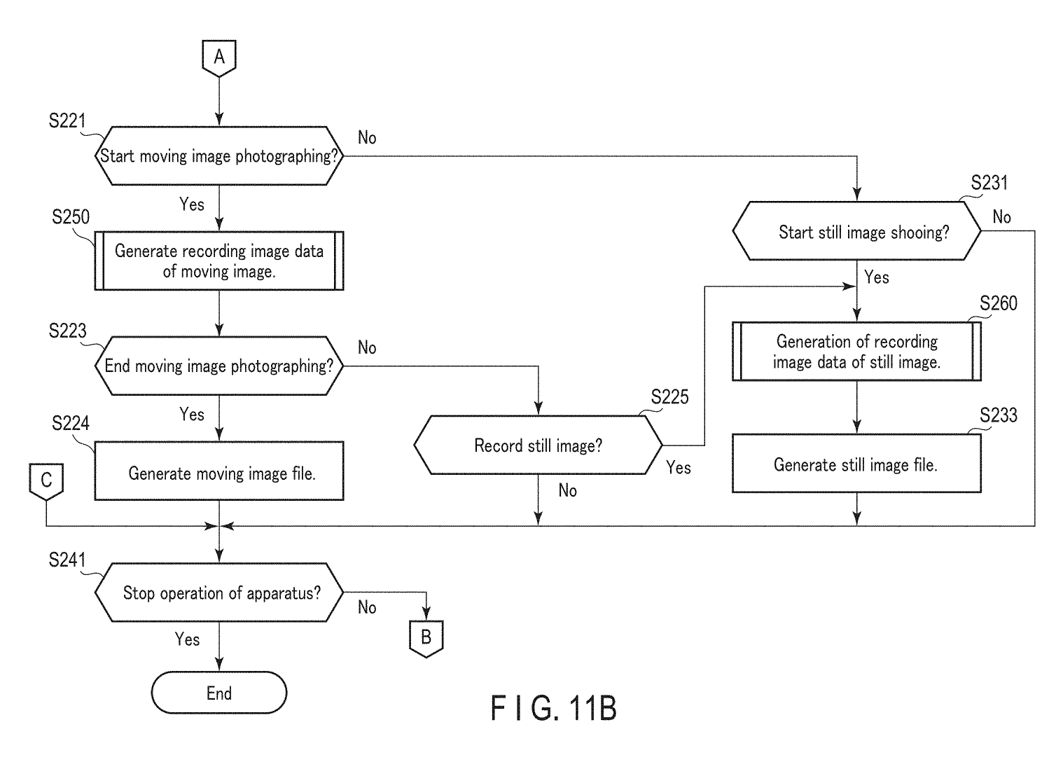

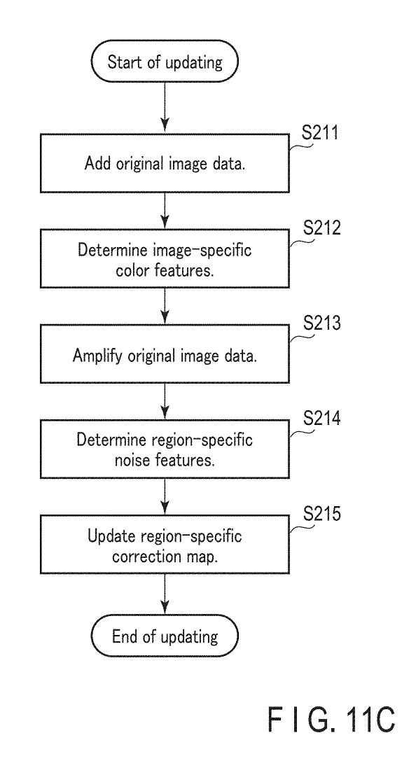

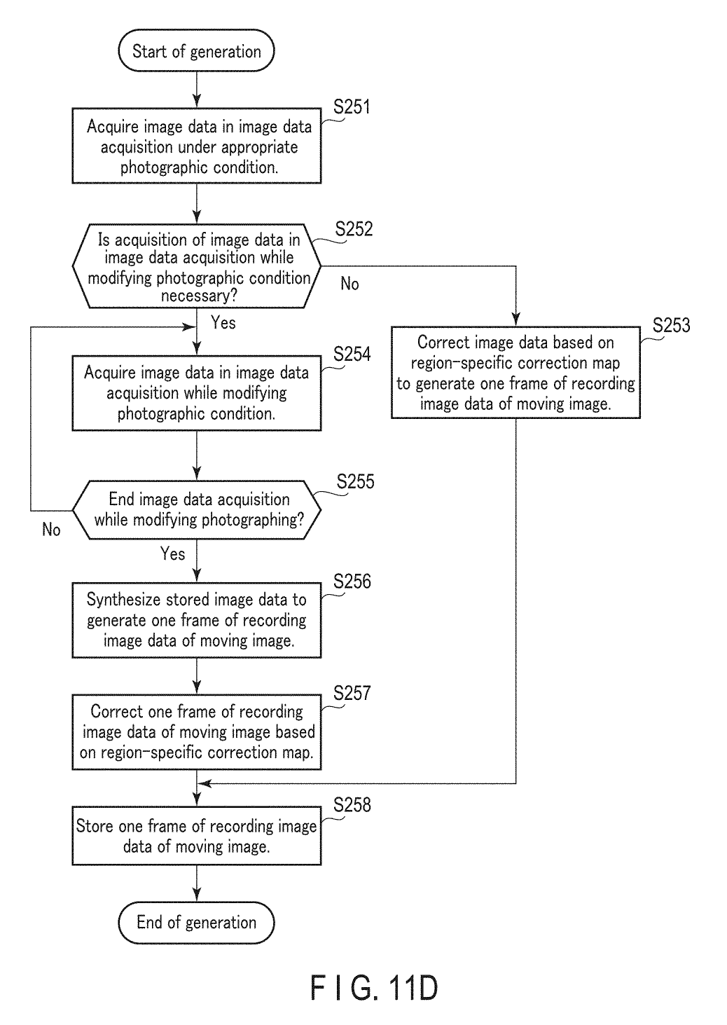

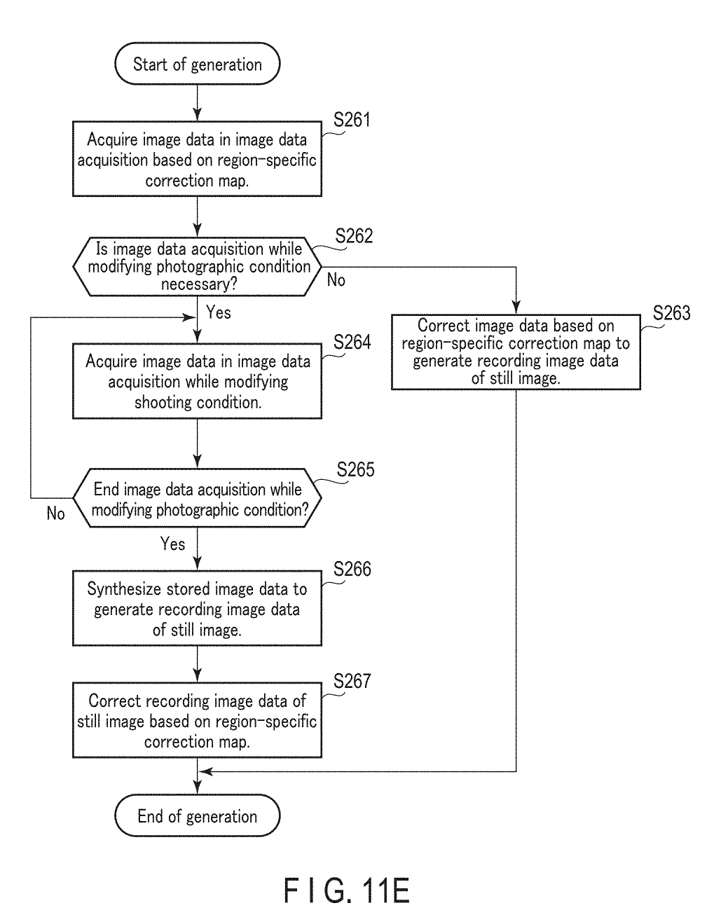

Next, the operation of the image processing apparatus 110 according to the present embodiment will be described. FIG. 11A and FIG. 11B show flowcharts of the photographing process in the imaging system 100 including the image processing apparatus 110 according to the present embodiment. The processes of FIG. 11A and FIG. 11B are performed mainly by the controller 114.

The flowcharts of FIGS. 11A and 11B illustrate the operation of the image processing apparatus 110 during a time from a standby state of waiting for start-up until the image processing apparatus 110 is stopped and returns to the standby state. In the following description, it is assumed that the imaging unit 130, the display 140, the recording unit 150, and the operation device 160 are all started up during the process of FIGS. 11A and 11B.

In the standby state, when a start/stop button of the operation device 160 is pressed by the user, the controller 114 determines that start-up of the image processing apparatus 110 has been instructed, and starts up the image processing apparatus 110.

After the image processing apparatus 110 is started up, in step S201, the controller 114 determines whether or not the current operation mode of the imaging system 100 is a photographing mode. The controller 114 stores the operation mode of the imaging system 100 set by the operation of the operation device 160 by the user. The controller 114 determines whether or not the current operation mode is the photographing mode according to the stored operation mode. In step S201, if it is determined that the operation mode is the photographing mode, the process proceeds to step S202a. Conversely, if it is determined in step S201 that the operation mode of the imaging system 100 is not the photographing mode, the process proceeds to step S209.

In step S209, the controller 114 performs other processes other than the photographing mode. The other processes regions described in the first embodiment After the other process is performed, the process proceeds to step S241.

In step S202a, the controller 114 causes the imaging unit 130 to perform image data acquisition under a first photographic condition through the data processor 112, and causes the image acquisition unit 112a to acquire first image data from the imaging unit 130 in the image data acquisition under the first photographic condition. In the present embodiment, the first photographic condition is a condition of exposure higher than the proper exposure. Therefore, the first image data is image data generated in image data acquisition under a condition of exposure higher than the proper exposure. In the following description, the first image data is also referred to as overexposed image data. Thereafter, the process proceeds to step S202b.

In step S202b, the controller 114 causes the imaging unit 130 to perform image data acquisition under a second photographic condition through the data processor 112, and causes the image acquisition unit 112a to acquire second image data from the imaging unit 130 in the image data acquisition under the second photographic condition. In the present embodiment, the second photographic condition is a condition of exposure lower than the proper exposure. Therefore, the second image data is image data generated in the image data acquisition under a condition of exposure lower than the proper exposure. In the following description, the second image data is also referred to as underexposed image data. Thereafter, the process proceeds to step S202c.

In step S202c, the controller 114 causes the HDR image data generator 112e to perform synthesis processing to the first image data and the second image data acquired by the image acquisition unit 112a to generate HDR image data. Thereafter, the process proceeds to step S203.

In step S203, the controller 114 causes the data processor 112 to output the HDR image data generated by the HDR image data generator 112e to the display 140. Furthermore, the controller 114 causes the display 140 to display an HDR image corresponding to the HDR image data to be input through the data processor 112. Thereafter, the process proceeds to step S204.

While the operation mode is the photographing mode, the processes of steps S202a to S202c and the process of step S203 are repeated. As a result, the HDR image data sequentially output from the imaging unit 130 is sequentially displayed on the display 140. That is, a live view of the HDR image is displayed on the display 140.

In step S204, the controller 114 causes the data processor 112 to determine whether or not the attitude of the imaging unit 130 is stable. For example, an attitude detection sensor, such as a gyro sensor, etc. is mounted on the imaging unit 130, although this is not illustrated in FIG. 10, and the data processor 112 determines whether or not the attitude of the imaging unit 130 is stable based on an output signal of the attitude detection sensor. If it is determined in step S204 that the attitude of the imaging unit 130 is stable, the process proceeds to step S205. Conversely, if it is determined in step S204 that the attitude of the imaging unit 130 is not stable, the process proceeds to step S221.

In step S205, the controller 114 causes the data processor 112 to determine whether or not the change in the subject is small. For example, the data processor 112 compares the one frame of image data acquired in steps S202a to S202c in the current loop processing with the one frame of image data acquired in steps S202a to S202c in the previous loop processing to determine whether or not the change in the subject is small, based on the comparison result. For example, the data processor 112 performs correlation analysis on such image data of two temporally continuous frames. Subsequently, the data processor 112 compares a correlation value obtained by the correlation analysis with a preset threshold value. The data processor 112 determines that the change in the subject is small if the correlation value is equal to or greater than the threshold value, and conversely, and determines that the change in the subject is not small if the correlation value is less than the threshold value. In step S205, if it is determined that the change in the subject is small, the process proceeds to step S206. Conversely, if it is determined in step S205 that the change in the subject is not small, the process proceeds to step S207.

In step S206, the controller 114 causes the data processor 112 to determine whether or not the current situation meets the conditions for updating the region-specific correction map. As described above, the region-specific correction map is updated based on frames of image data. One condition for updating the region-specific correction map is that a predetermined fixed number of frames of image data necessary for updating the region-specific correction map are accumulated in the image analyzer 112b. For example, if the predetermined fixed number of frames of image data are accumulated, the data processor 112 determines that the current situation meets the updating conditions. Conversely, if the predetermined fixed number of frames of image data are not accumulated, the data processor 112 determines that the current situation does not meet the updating conditions. In step S206, if it is determined that the current situation meets the conditions for updating the region-specific correction map, the process proceeds to step S210 in which the region-specific correction map is updated. Conversely, if it is determined in step S206 that the current situation does not meet the conditions for updating the region-specific correction map, the process proceeds to step S207.

Herein, the update of the region-specific correction map will be described with reference to FIG. 11C. FIG. 11C is a flowchart of processing for updating the region-specific correction map in step S210.

In step S211, the controller 114 causes the adder 112c of the image analyzer 112b to perform addition processing to the original image data. Original image data to be subjected to the addition processing is mainly the second image data, i.e., underexposed image data, and there is no need to perform the addition processing to the first image data, i.e., overexposed image data. This is because the first image data, i.e., overexposed image data tends to be over-ranging due to the addition processing. This addition processing is not always necessary and may be omitted. Subsequently, the process proceeds to step S212.

In step S212, the controller 114 causes the image analyzer 112b to determine region-specific color features. For example, the image analyzer 112b performs color determination for each of a large number of minute regions set for each of the image data, and classifies the minute regions according to the determination result. At that time, information obtained by comparing the original image data may be used, and information obtained by comparing the original image data and the added image data may also be used. Thereafter, the process proceeds to step S213.

In step S213, the controller 114 causes the image analyzer 112b to amplify the original image data. In the following description, the amplified original image data is referred to as amplified image data. In the amplified image data, components attributable to a subject as well as components attributable to noise are increased as compared to the original image data. The original image data to be amplified is mainly the second image data, i.e., underexposed image data, and there is little need to perform the amplification processing to the first image data, i.e., overexposed image data. This is because the first image data, i.e., overexposed image data tends to be over-ranging due to the amplification processing. Thereafter, the process proceeds to step S214.

In step S214, the controller 114 causes the image analyzer 112b to determine region-specific noise features. The image analyzer 112b compares the original image data, the added image data, and the amplified image data, for each of a large number of minute regions set for each image data to thereby determine whether data of the pixels belonging to a minute region is mainly attributable to the subject or mainly attributable to noise, and to classify each minute region according to the determination result. Thereafter, the process proceeds to step S215.

In step S215, the controller 114 causes the image analyzer 112b to update the region-specific correction map. The image analyzer 112b newly sets regions for the imaging range of the imaging unit 130 and updates the region-specific correction map by newly setting the correction information on each of the regions. The update of the region-specific correction map is performed as described in the first embodiment. Thereafter, the process proceeds to step S207 shown in FIG. 11A.

In step S207 shown in FIG. 11A, the controller 114 causes the data processor 112 to determine whether or not the change in the subject is large. For example, the data processor 112 compares one frame of image data acquired in steps S202a to S202c in the current loop processing with one frame of image data acquired in steps S202a to S202c in the previous loop processing to determine whether or not the change in the subject is large, based on the comparison result. This determination is carried out, for example, by the same processing as in step S205. In step S207, if it is determined that the change in the subject is large, the process proceeds to step S208. Conversely, if it is determined in step S207 that the change in the subject is not large, the process proceeds to step S221.

In step S208, the controller 114 causes the image analyzer 112b to reset the region-specific correction map. The image analyzer 112b erases all region-specific information of the region-specific correction map. Along with this, the image analyzer 112b discards all the frames of image data temporarily accumulated for updating the region-specific correction map. Thereafter, the process proceeds to step S221.

In step S221, the controller 114 determines whether or not the start of moving image photographing has been instructed. For example, when the moving image button of the operation device 160 is pressed by the user, the controller 114 determines that the start of moving image photographing has been instructed. In step S221, if it is determined that the start of moving image photographing has been instructed, the process proceeds to step S250 for generating moving image recording image data. If it is determined in step S221 that the start of moving image photographing is not instructed, the process proceeds to step S231.

In step S250, the controller 114 causes the data processor 112 to generate one frame of recording image data of the moving image. Thereafter, the process proceeds to step S223.

Herein, the generation of moving image recording image data will be described with reference to FIG. 11D. FIG. 11D is a flowchart of the process of generating moving image recording image data in step S250.

In step S251, the controller 114 causes the imaging unit 130 to perform image data acquisition in an appropriate photographic condition, for example, a proper exposure condition, through the data processor 112. The image acquisition unit 112a acquires image data output from the imaging unit 130 and outputs the acquired image data to the image analyzer 112b. The image analyzer 112b accumulates the image data that has been input. Thereafter, the process proceeds to step S252.

In step S252, the controller 114 causes the image analyzer 112b to determine whether or not image data acquisition while modifying the photographic condition based on the region-specific correction map is necessary. In step S252, if it is determined that image data acquisition while modifying the photographic condition is not necessary, the process proceeds to step S253. Conversely, if it is determined in step S252 that image data acquisition while modifying the photographic condition is necessary, the process proceeds to step S254.

In step S253, the controller 114 causes the recording image data generator 112d to generate recording image data. The recording image data generator 112d reads out the region-specific correction map from the image analyzer 112b. In addition, the recording image data generator 112d reads out the image data accumulated in the image analyzer 112b in step S251. Furthermore, the recording image data generator 112d corrects the read image data based on the region-specific correction map to thereby generate one frame of recording image data. Thereafter, the process proceeds to step S258.

In step S254, the controller 114 causes the imaging unit 130 to perform image data acquisition while modifying the photographic condition, for example, the exposure condition, through the data processor 112. The image acquisition unit 112a acquires the image data output from the imaging unit 130 and outputs the acquired image data to the image analyzer 112b. The image analyzer 112b accumulates the image data that has been input. Thereafter, the process proceeds to step S255.

In step S255, the controller 114 causes the data processor 112 to determine whether or not the image data acquisition while modifying the photographic condition has been ended. The determination on whether or not the image data acquisition while modifying the photographic condition has been ended is performed by determining whether or not the image data acquisition of frames necessary for synthesis has been ended. In step S255, if it is determined that the image data acquisition while modifying the photographic condition is not ended, the process returns to step S254. Conversely, if it is determined in step S255 that the image data acquisition while modifying the photographic condition has been ended, the process proceeds to step S256.

In step S256, the controller 114 causes the recording image data generator 112d to generate recording image data. The recording image data generator 112d reads out the frames of image data accumulated in the image analyzer 112b in step S251 and step S254. The image analyzer 112b generates one frame of recording image data by synthesizing the read frames of image data. Thereafter, the process proceeds to step S257.

In step S257, the controller 114 causes the recording image data generator 112d to correct the recording image data. The recording image data generator 112d reads out the region-specific correction map from the image analyzer 112b. In addition, the recording image data generator 112d corrects the recording image data generated in step S256 based on the read region-specific correction map. Thereafter, the process proceeds to step S258.

Since the image data synthesized for generating the recording image data in step S256 includes the image data in the image data acquisition under the photographic conditions that have been modified based on the region-specific correction map, the information of the region-specific correction map has been reflected in the recoding image data generated in step S256. For this reason, the correction processing in step S257 is not necessarily required and may be omitted.

In step S258, the controller 114 causes the recording image data generator 112d to accumulate recording image data. The recording image data generator 112d accumulates the recording image data generated in step S253, the recording image data generated in step S256, or the recording image data generated in step S256 and then corrected in step S257. Thereafter, the process proceeds to step S223 shown in FIG. 11B. As described later, the generation of moving image recording image data described with reference to FIG. 11D is continued until the end of moving image photographing is instructed.

In the present embodiment, an example is described, in which first, image data is acquired in the image data acquisition under an appropriate photographic condition, and thereafter, as necessary, image data is acquired in image data acquisition under the photographic conditions that have been modified based on the region-specific correction map; however, the present embodiment is not limited thereto. Image data may be acquired from the beginning in image data acquisition under photographic conditions based on the region-specific correction map. In this case, the recording image data is composed of one frame of image data obtained in the image data acquisition while modifying the photographic condition based on the region-specific correction map or synthesized one frame of image data obtained by synthesizing frames of image data in the image data acquisition while modifying the photographic conditions based on the region-specific correction map.

The “image data acquisition while modifying the photographic condition based on the region-specific correction map” indicates acquisition of a series of image data acquisitions performed in steps S251 and S254 and differs from “image data acquisition while the photographic condition is repeatedly modified according to the predetermined rule” performed in Step S202a, S202b for the purpose of acquiring HDR image data.

In step S223 shown in FIG. 11B, the controller 114 determines whether or not the end of moving image photographing has been instructed. For example, when the moving image button of the operation device 160 is pressed again by the user, the controller 114 determines that the end of moving image photographing has been instructed. In step S223, if it is determined that the end of moving image photographing has been instructed, the process proceeds to step S224. Conversely, if it is determined in step S223 that the end of moving image photographing is not instructed, the process proceeds to step S225.

In step S224, the controller 114 causes the recording image data generator 112d to generate a moving image file. As described with reference to FIG. 13A, the moving image file includes image data, thumbnails, accompanying information, and synthesis source image-specific accompanying information. The image data is composed of temporally continuous frames of recording image data accumulated in the recording image data generator 112d in step S258 until the end of moving image photographing is instructed. The controller 114 also causes the recording image data generator 112d to output the generated moving image file to the recording unit 150. The controller 114 causes the recording unit 150 to record the input moving image file in the moving image recorder 154 through the data processor 112. Thereafter, the process proceeds to step S241.

In step S225, the controller 114 determines whether still image photographing has been instructed. For example, when a release button of the operation device 160 is pressed by the user, the controller 114 determines that still image photographing has been instructed. In step S225, if it is determined that still image photographing has been instructed, the process proceeds to step S260. In step S225, if it is determined that still image photographing is not instructed, the process proceeds to step S241.

As described above, if it is determined in step S221 that the start of moving image photographing is not instructed, the process proceeds to step S231. In step S231, the controller 114 determines whether or not still image photographing has been instructed. This determination is made, for example, by the same processing as step S225. In step S231, if it is determined that still image photographing has been instructed, the process proceeds to step S260. In step S231, if it is determined that still image photographing is not instructed, the process proceeds to step S241.

In step S260, the controller 114 causes the data processor 112 to generate recording image data of still images. Thereafter, the process proceeds to step S233.

Herein, generation of recording image data of still images will be described with reference to FIG. 11E. FIG. 11E is a flowchart of the process of generating recording image data of still images in step S260.

In step S261, the controller 114 causes the imaging unit 130 to perform image data acquisition an under appropriate photographic condition, e.g., an appropriate exposure condition, through the data processor 112. The image acquisition unit 112a acquires the image data output from the imaging unit 130 and outputs the acquired image data to the image analyzer 112b. The image analyzer 112b accumulates input image data. Thereafter, the process proceeds to step S262.

In step S262, the controller 114 causes the image analyzer 112b to determine whether or not image data acquisition while modifying the photographic condition based on the region-specific correction map is necessary. In step S262, if it is determined that the image data acquisition while modifying the photographic condition is not necessary, the process proceeds to step S263. Conversely, if it is determined in step S262 that the image data acquisition while modifying the photographic condition is necessary, the process proceeds to step S264.

In step S263, the controller 114 causes the recording image data generator 112d to generate recording image data. The recording image data generator 112d reads out the region-specific correction map from the image analyzer 112b. In addition, the recording image data generator 112d reads out the image data accumulated in the image analyzer 112b in step S261. Furthermore, the recording image data generator 112d generates one frame of recording image data by correcting the read image data based on the region-specific correction map. Thereafter, the process proceeds to step S268.

In step S264, the controller 114 causes the imaging unit 130 to modify the photographic condition, e.g., exposure conditions, and to perform image data acquisition through the data processor 112. The image acquisition unit 112a acquires the image data output from the imaging unit 130 and outputs the acquired image data to the image analyzer 112b. The image analyzer 112b accumulates image data that has been input. Thereafter, the process proceeds to step S265.

In step S265, the controller 114 causes the data processor 112 to determine whether or not the image data acquisition while modifying the photographic condition has been ended. If it is determined in step S265 that the image data acquisition while modifying the photographic condition is not ended, the process returns to step S264. Conversely, if it is determined in step S265 that the image data acquisition while modifying the photographic condition has been ended, the process proceeds to step S266.

In step S266, the controller 114 causes the recording image data generator 112d to generate recording image data. The recording image data generator 112d reads out the frames of image data accumulated in the image analyzer 112b in step S261 and step S264. The image analyzer 112b generates one frame of recording image data by synthesizing frames of image data. Thereafter, the process proceeds to step S267.

In step S267, the controller 114 causes the recording image data generator 112d to correct the recording image data. The recording image data generator 112d reads out the region-specific correction map from the image analyzer 112b. In addition, the recording image data generator 112d corrects the recording image data generated in step S266 based on the read region-specific correction map. This correction processing is not necessarily required for the reason described above and may be omitted. Thereafter, the process proceeds to step S233 shown in FIG. 11B.

In the present embodiment, an example is described, in which first, image data is acquired in the image data acquisition under an appropriate photographic condition, and thereafter, as necessary, image data is acquired in image data acquisition under the photographic conditions that have been modified based on the region-specific correction map; however, the present embodiment is not limited thereto. As with the generation of moving image recording image data, image data may be acquired in the image data acquisition under the photographic condition based on the region-specific correction map from the beginning.

In step S233 shown in FIG. 11B, the controller 114 causes the recording image data generator 112d to generate a still image file and record the generated still image file in a still image recorder 152. The generation and recording of a still image file are performed in the same manner as in the third embodiment. Thereafter, the process proceeds to step S241.

In step S233 shown in FIG. 11B, the controller 114 causes the recording image data generator 112d to generate a still image file. As described with reference to FIG. 13A, the still image file includes image data, thumbnails, accompanying information, and image-specific synthesis source accompanying information. In step S267, the image data is composed of one frame of recording image data generated by the recording image data generator 112d. The controller 114 causes the recording image data generator 112d to output the generated still image file to the recording unit 150. The controller 114 causes the recording unit 150 to record the input still image file in the still image recorder 152 through the data processor 112. Thereafter, the process proceeds to step S241.

In step S241, the controller 114 determines whether or not the stop of the image processing apparatus 110 has been instructed. For example, when the start/stop button of the operation device 160 is pressed again by the user, the controller 114 determines that the stop of the image processing apparatus 110 has been instructed. If it is determined in step S241 that the stop of the image processing apparatus 110 is not instructed, the process returns to step S201. Conversely, if it is determined in step S241 that the stop of the image processing apparatus 110 has been instructed, the controller 114 stops the image processing apparatus 110, and the image processing apparatus 110 returns to the standby state again.

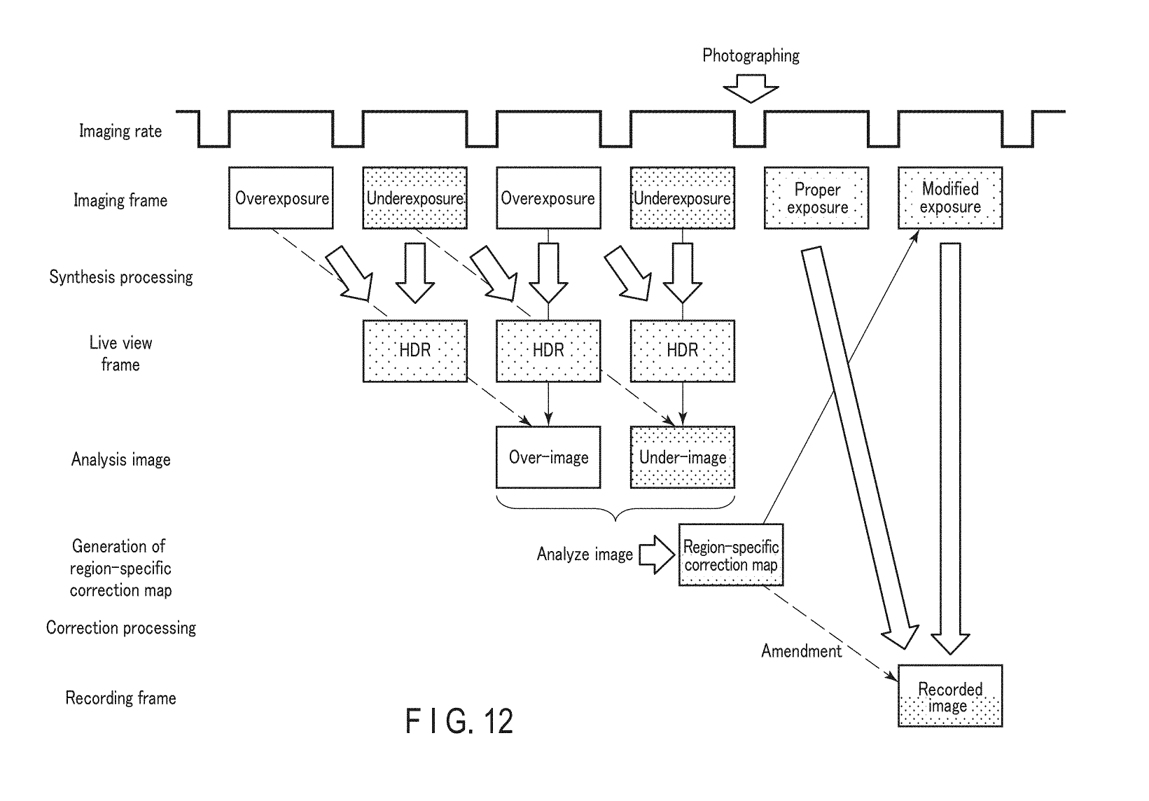

FIG. 12 is a timing chart showing the photographing operation performed in this way. FIG. 12 shows operations before and after photographing a still image.

In FIG. 12, “imaging rate” indicates imaging timing. “Imaging frame” represents image data and exposure setting in each photographing. Herein, “Overexposure” represents first image data, i.e., image data in photographing under a condition of exposure higher than the proper exposure, “Underexposure” represents second image data, i.e., image data in photographing under a condition of exposure lower than the proper exposure. “Proper exposure” represents image data in an image data acquisition with proper exposure, and “modified exposure” represents image data in an image data acquisition with exposure modified based on the region-specific correction map.

“Live view frame” represents an image displayed on a display 140. “HDR” represents an HDR image generated by performing synthesis processing to “overexposed” image data and “underexposed” image data.

“Analysis image” represents image data to be subjected to image analysis. “Over-image” represents “overexposed” image data or image data in which “overexposed” image data is subjected to, for example, addition processing. Additionally, “under image” represents “underexposed” image data or image data in which “underexposed” image is subjected to, for example, addition processing.

“Correction map” represents “the region-specific correction map” stored in the image analyzer 112b. “Recording frame” represents recorded image data generated by synthesizing the image data of “proper exposure” and the image data of “modified exposure”.

“Photographing” represents the timing at which still image photographing has been instructed. Until “photographing” is instructed, the image data of the “imaging frame” is composed of “overexposed” image data and “underexposed” image data that are alternately generated in the image data acquisition under an alternately modified exposure condition. Also, the image data of “live view frame” is generated based on these “overexposed” image data and “underexposed” image data.

In contrast, immediately after the instructions for still image photographing, the image data of the “imaging frame” is composed of the image data of “proper exposure” in the image data acquisition with the proper exposure and the image data in the image data acquisition with “modified exposure” in the image data acquisition with the modified exposure. Prior to the still image photographing, the generation of the live view frame is stopped. Therefore, the image data is not used for generating the image data of “live view frame”. By performing synthesis processing to the image data of “proper exposure” and the image data of “modified exposure”, the image data of “recorded image” of “recording frame” is generated. Furthermore, the image data of the “recorded image” may be corrected based on the “region-specific correction map” as necessary.

As described above, according to the image processing apparatus of the present embodiment, an optimum image corresponding to the subject can be obtained by modifying the photographic condition to photographic conditions (for example, the exposure condition) based on the region-specific correction map containing correction information relating to the subject being photographed. In addition, an optimum image corresponding to the subject can be obtained by synthesizing image data in the image data acquisition while modifying the photographic condition based on the region-specific correction map, and also by correcting the synthesized image data based on the region-specific correction map.

For example, by acquiring image data under favorable exposure conditions for each subject several times, and synthesizing the image data obtained in these image data acquisitions, it is possible to form recorded image in which each subject is recorded colorfully, sharply, and clearly, with the original color tone.

It is also possible to store, as a program that can be executed by a computer, each process performed by the controller 114 according to the present embodiment. The program can be stored in a recording medium of an external storage device, such as a magnetic disk, an optical disk, a semiconductor memory, or the like, so as to be distributed. Then, the computer reads out the program stored in a recording medium of the external storage device and operates according to the read program, thereby making it possible for the computer to execute each of the processes performed by the controller 114.

### Fourth Embodiment

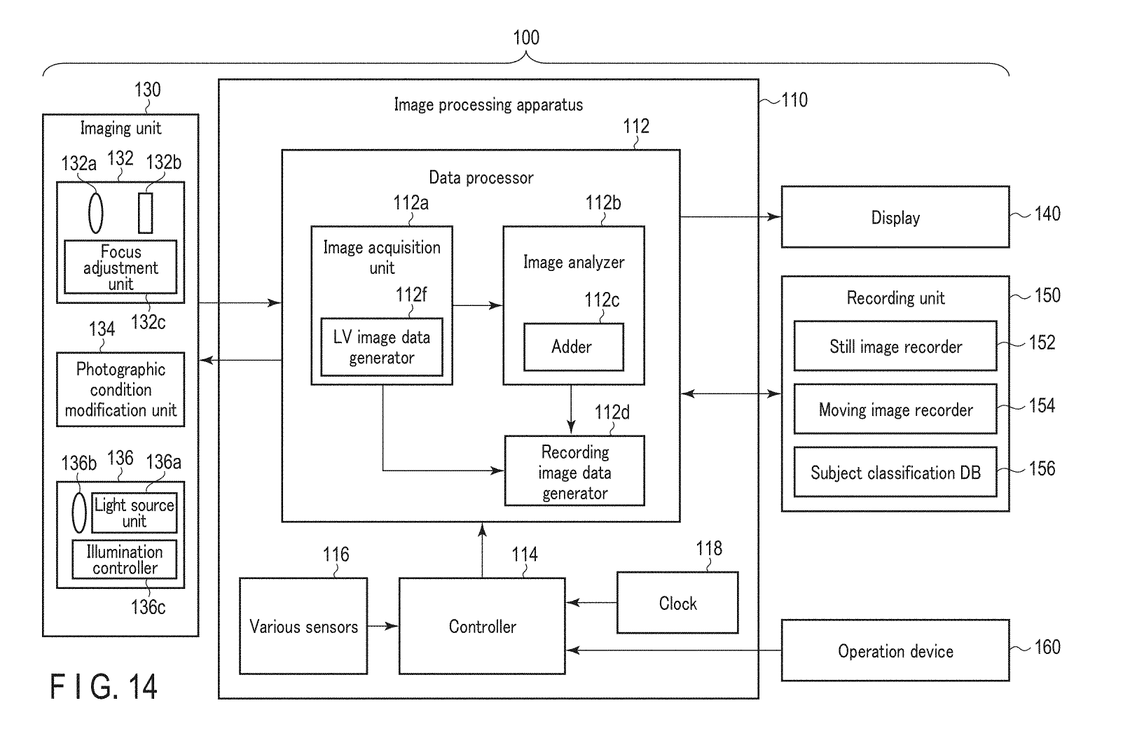

Next, a fourth embodiment will be described with reference to the drawings. FIG. 14 is a block diagram showing the configuration of an imaging system including an image processing apparatus according to the fourth embodiment. In FIG. 14, members denoted by the same reference signs as those shown in FIG. 10 are similar members, and the detailed description thereof will be omitted. Hereinafter, an explanation will be given focusing on differences. Namely, the parts not mentioned in the following description are the same as those in the third embodiment. In addition to FIG. 14, in the present application, FIGS. 1, 7, and 10 also show the block diagrams. The figures are specialized for explaining the respective embodiments. In the embodiments, the essential difference is small and information prior to photographing is used effectively.

As in the third embodiment, the present embodiment is intended to obtain an optimum image corresponding to a subject.

In the present embodiment, the image acquisition unit 112a includes an LV image data generator 112f instead of the HDR image data generator 112e. Also in the present embodiment, the image acquisition unit 112a sequentially acquires, from the imaging unit 130, image data in the image data acquisition while the photographic condition is repeatedly modified according to an appropriate predetermined appropriate rule. The LV image data generator 112f generates a live view image based on the image data in the image data acquisition under a series of photographic conditions. LV image data is generated by performing synthesis processing to frames of image data in the series of photographic conditions.

From the viewpoint of the way of generating image data, LV image data according to the present embodiment can be said to be similar to the HDR image data; however, the LV image data according to the present embodiment means image data with a broader scope of concept encompassing HDR image data. In other words, the LV image data may, of course, be HDR image data, of course, or may be image data of a type different from HDR image data.

The imaging unit 130 includes an illuminator 136 configured to emit illumination light for illuminating a subject. The illuminator 136 includes a light source unit 136a, an illumination optical system 136b, and an illumination controller 136c.

The light source unit 136a is configured to selectively emit types of illumination light. Therefore, the light source unit 136a has, for example, light sources configured to emit different types of illumination light. For example, the light source unit 136a includes a white light source, a violet light source, a blue light source, a green light source, a red light source, an infrared light source, etc. These light sources may be narrowband light sources such as laser diodes, except for a white light source. The light source unit 136a can also emit illumination light in which light emitted from light sources is combined.

The illumination optical system 136b include an aperture, a lens, etc., and appropriately adjusts the characteristics of the illumination light coming from the light source unit 136a, and emits the illumination light to the outside of the imaging unit 130. For example, the illumination optical system 136b equalizes the intensity distribution of the illumination light or adjusts the spread angle of the illumination light. The illumination optical system 136b may also have a fluorescent substance, which is excited by a specific light, for example, blue light to emit fluorescent light.

The illumination controller 136c controls the light source unit 136a and the illumination optical system 136b. For example, the illumination controller 136c selects a light source to be turned on in the light source unit 136a, adjusts the output light quantity of the light source that is turned on, adjusts the position of the lens in the illumination optical system 136b, etc.

The illumination controller 136c is controlled by a photographic condition modification unit 134. In other words, the photographic condition modification unit 134 modifies the photographic conditions, for example, the exposure of the imager 132, and also performs the above-mentioned various adjustments of illuminator 136, for example, the selection of illumination light and output adjustment of illumination light. That is, in the present embodiment, the illumination conditions include not only various adjustments related to the imager 132, but also various adjustments of the illuminator 136.

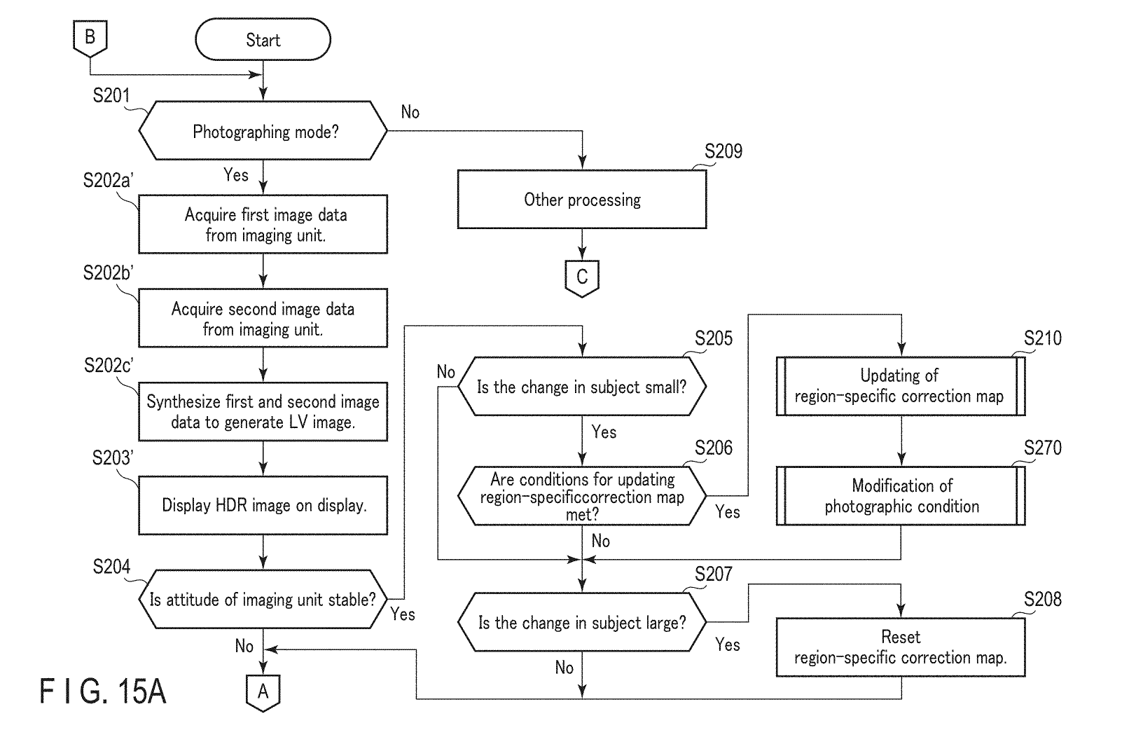

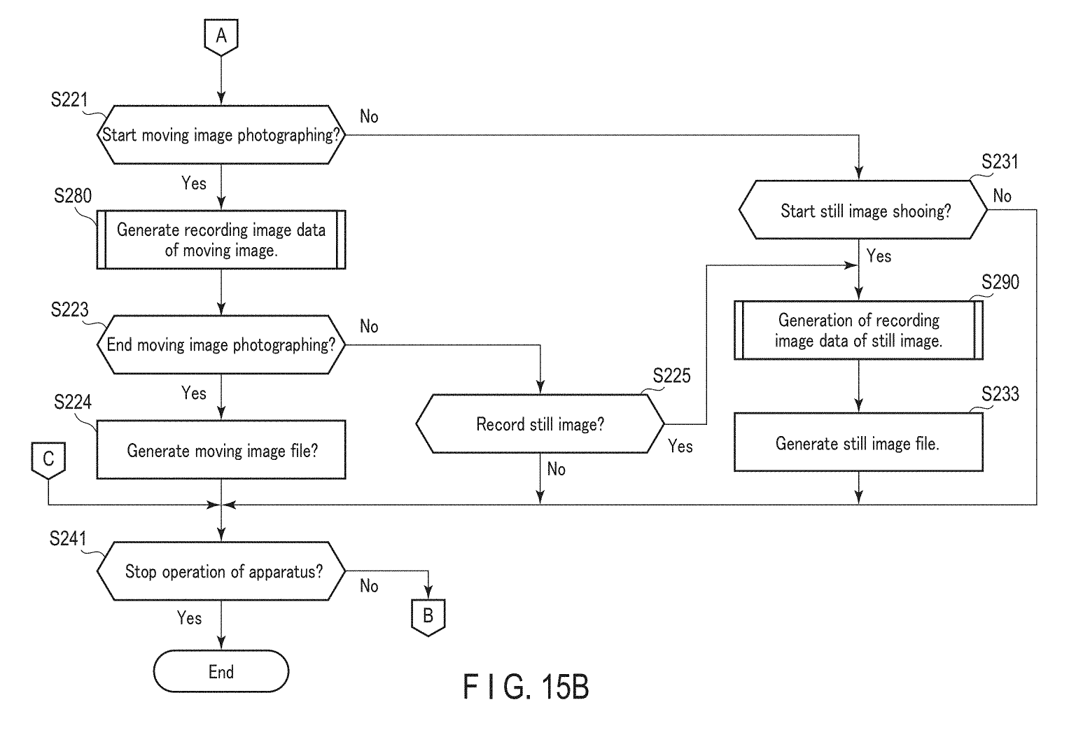

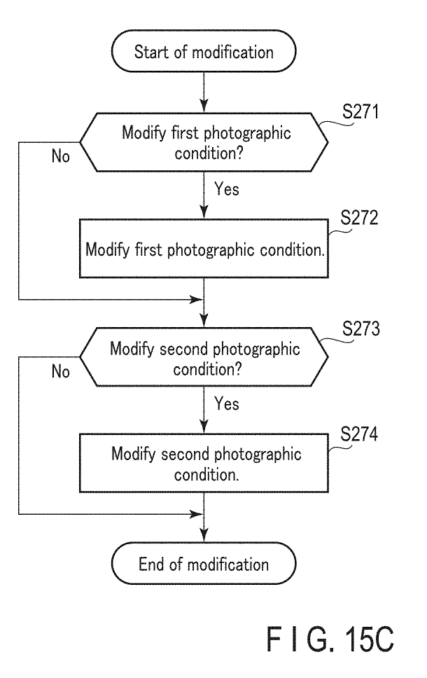

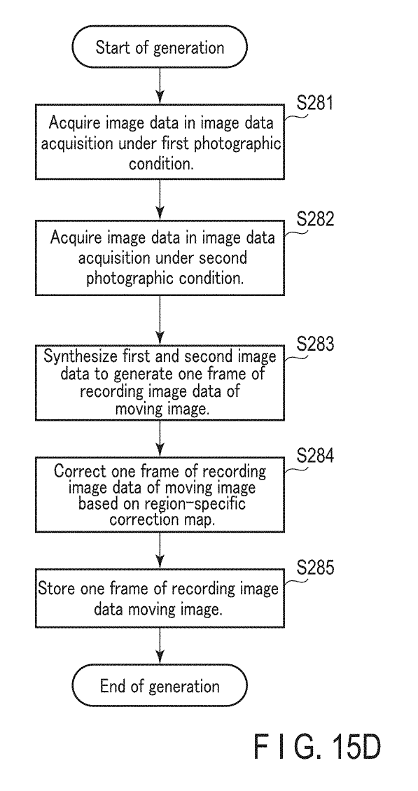

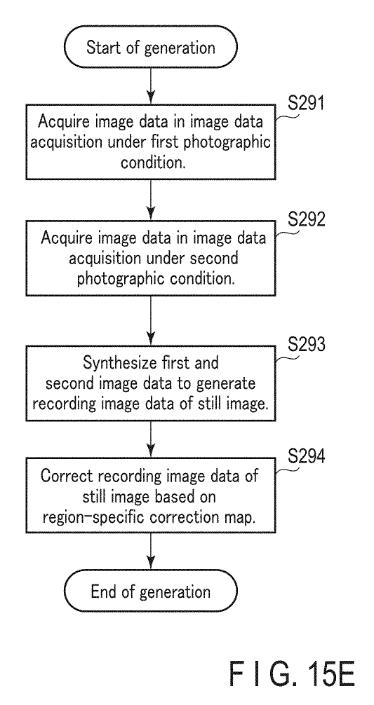

Next, the operation of the image processing apparatus 110 according to the present embodiment will be described. FIG. 15A and FIG. 15B show flowcharts of the photographing process in the imaging system 100 including an image processing apparatus 110 according to the present embodiment. In FIG. 15A and FIG. 15B, the blocks denoted by the same reference signs as the blocks shown in FIGS. 11A and 11B represent the same processing, and the detailed description thereof will be omitted.

The flowcharts of FIGS. 15A and 15B illustrate the operation of the image processing apparatus 110 during a time from a standby state of waiting for start-up until the image processing apparatus 110 is stopped and returns to the standby state. In the following description, as in the description of the third embodiment, it is assumed that the imaging unit 130, display 140, recording unit 150, and operation device 160 are all started up during the process of FIGS. 15A and 15B.

In the standby state, when a start/stop button of the operation device 160 is pressed by the user, the controller 114 determines that start-up of the image processing apparatus 110 has been instructed, and the image processing apparatus 110 is started up.

After the image processing apparatus 110 is started up, in step S201, the controller 114 determines whether or not the current operation mode of the imaging system 100 is the photographing mode. This determination is performed in the same manner as in the third embodiment. In step S201, if it is determined that the operation mode is the photographing mode, the process proceeds to step S202a′. Conversely, if it is determined in step S201 that the operation mode of the imaging system 100 is not the photographing mode, the process proceeds to step S209.

In step S209, the controller 114 performs other processes other than the photographing mode. The other processes are as described in the first embodiment. After the other process is performed, the process proceeds to step S241.

In step S202a′, the controller 114 causes the image acquisition unit 112a of the data processor 112 to perform image data acquisition under a first photographic condition into the imaging unit 130 and to acquire first image data in the image data acquisition under the first photographic condition from the imaging unit 130. The controller 114 also causes the image acquisition unit 112a to temporarily accumulate the acquired first image data. Thereafter, the process proceeds to step S202b′.

In step S202b′, the controller 114 causes the image acquisition unit 112a of the data processor 112 to perform image data acquisition under a second photographic condition in the imaging unit 130 and to acquire second image data in the image data acquisition under the second photographic condition from the imaging unit 130. The controller 114 also causes the image acquisition unit 112a to temporarily accumulate the acquired second image data. Thereafter, the process proceeds to step S202c′.

In the present embodiment, the second photographic condition is not necessarily different from the first photographic condition. Namely, the second photographic condition may be the same as the first photographic condition.

In step S202 c′, the controller 114 causes the LV image data generator 112f to perform synthesis processing to the first image data and the second image data acquired by the image acquisition unit 112a and to generate LV image data. Thereafter, the process proceeds to step S203′.

In step S203′, the controller 114 causes the data processor 112 to output the LV image data generated in the LV image data generator 112f to the display 140. Furthermore, the controller 114 causes the display 140 to display an LV image corresponding to the input LV image data through the data processor 112. Thereafter, the process proceeds to step S204.

While the operation mode is the photographing mode, the processes of steps S202a′ to S202c′ and the process of step S203′ are repeated. As a result, a live view of the LV image is displayed on the display 140.

In step S204, the controller 114 causes the data processor 112 to determine whether or not the attitude of the imaging unit 130 is stable. This determination is performed in the same manner as in the third embodiment. In step S204, if it is determined that the attitude of the imaging unit 130 is stable, the process proceeds to step S205. Conversely, if it is determined in step S204 that the attitude of the imaging unit 130 is not stable, the process proceeds to step S221.

In step S205, the controller 114 causes the data processor 112 to determine whether or not the change in the subject is small. This determination is performed in the same manner as in the third embodiment. In step S205, if it is determined that the change in the subject is small, the process proceeds to step S206. Conversely, if it is determined in step S205 that the change in the subject is not small, the process proceeds to step S207.

In step S206, the controller 114 causes the data processor 112 to determine whether or not the current situation meets the conditions for updating the region-specific correction map. This determination is performed in the same manner as in the third embodiment. In step S206, if it is determined that the current situation does not meet the conditions for updating the region-specific correction map, the process proceeds to step S207. Conversely, in step S206, if it is determined that the current situation meets the conditions for updating the region-specific correction map, the process proceeds to step S210. The process of updating the region-specific correction map in step S210 is as described in the third embodiment. Thereafter, the process proceeds to step S270 of modifying the photographic condition.

Herein, the modification of the photographic condition will be described with reference to FIG. 15C. FIG. 15C is a flowchart of the process of modifying the photographic condition in step S270.

In step S271, the controller 114 causes an image analyzer 112b to determine whether or not it is necessary to modify a first photographic condition based on the region-specific correction map. In step S271, if it is determined that it is necessary to modify the first photographic condition, the process proceeds to step S272. Conversely, if it is determined in step S271 that it is not necessary to modify the first photographic condition, the process proceeds to step S273.

In step S272, the controller 114 causes the photographic condition modification unit 134 to modify the first photographic condition through the data processor 112. The controller 114 causes the image analyzer 112b to calculate a new first photographic condition to be applied after the modification based on the region-specific correction map and to output information of the new first photographic condition to the photographic condition modification unit 134 of the imaging unit 130. The photographic condition modification unit 134 modifies the first photographic condition according to the information of the new first photographing that has been input. Thereafter, the process proceeds to step S273.

In step S273, the controller 114 causes the image analyzer 112b to determine whether or not it is necessary to modify a second photographic condition based on the region-specific correction map. In step S273, if it is determined that it is necessary to modify the second photographic condition, the process proceeds to step S274. Conversely, if it is determined in step S273 that it is not necessary to modify the second photographic condition, the process proceeds to step S207 shown in FIG. 15B.

In step S274, the controller 114 causes the photographic condition modification unit 134 to modify the second photographic condition through the data processor 112. The controller 114 causes the image analyzer 112b to calculate a new second photographic condition to be applied after the modification based on the region-specific correction map and to output information of the new second photographic condition to the photographic condition modification unit 134 of the imaging unit 130. The photographic condition modification unit 134 modifies the first photographic condition according to the information of the new second photographic condition that has been input. Thereafter, the process proceeds to step S207 shown in FIG. 15A.

The processing of modifying the photographic condition in step S270 is performed, for example, during the acquisition of live view image data. As a result, the image data acquisition while modifying the photographic condition based on the region-specific correction map is started during the acquisition of live view image data.

The image data acquisition while modifying the photographic condition is performed, but the image data acquisition while modifying the photographic condition up to that point does not correspond to “image data acquisition while modifying the photographic condition based on the region-specific correction map”.

The process of modifying the photographic condition in step S270 is not limited to during the time of acquiring live view image data, but may be performed at a different timing, for example, in response to the operation of the operation device 160 by the user instructing recording of an image. Namely, the process may be performed at the same time as the instructions for recording an image by the user. In this case, the image data acquisition while modifying the photographic condition based on the region-specific correction map is started at the time of recording the image.

Therefore, the instructions for image recording image may be a condition when a modification of the photographic condition is determined. For example, an image to be viewed in live view and an image to be recorded are set in advance by the user, and the process of modifying the photographic condition is performed by referring to the settings when instructions to record an image is received.

In the case where the image recording instructions are instructions to photograph a still image, the modified photographic condition may be returned to the original photographic condition immediately after the still image is recorded or may be continued as is even after the still image is recorded.

Alternatively, the process of modifying the photographic condition in step S270 may be performed during photographing of a moving image. In this case, the image data acquisition while modifying the photographic condition based on the region-specific correction map is started during the image data acquisition of the moving image.

Modifying the photographic condition during photographing of a moving image may be performed automatically or manually. Manually modifying the photographic condition during photographing of a moving image is performed, for example, in such a manner that a message proposing to modify the photographic condition is displayed on the display 140, and the controller 114 that has detected the operation of the operation device 160 by the user who has accepted the proposal causes the data processor 112 to output information instructing to modify the photographic condition to the photographic condition modification unit 134.

In step S207 illustrated in FIG. 15A, the controller 114 causes the data processor 112 to determine whether or not the change in the subject is large. This determination is performed in the same manner as in the third embodiment. In step S207, if it is determined that the change in the subject is large, the process proceeds to step S208. Conversely, if it is determined in step S207 that the change in the subject is not large, the process proceeds to step S221.

In step S208, the controller 114 causes the image analyzer 112b to reset the region-specific correction map. The resetting of the region-specific correction map is performed in the same manner as in the third embodiment. Thereafter, the process proceeds to step S221.

In step S221, the controller 114 determines whether or not start of moving image photographing has been instructed. For example, when a moving image button of the operation device 160 is pressed by the user, the controller 114 determines that start of moving image photographing has been instructed. If it is determined in step S221 that start of moving image photographing has been instructed, the process proceeds to step S280. If it is determined in step S221 that start of moving image photographing is not instructed, the process proceeds to step S231.

In step S280, the controller 114 causes the data processor 112 to generate one frame of recording image data of the moving image. Thereafter, the process proceeds to step S223.

Herein, generation of recording image data of a moving image will be described with reference to FIG. 15D. FIG. 15D is a flowchart of the process of generating recording image data of a moving image in step S280.

In step S281, the controller 114 causes the image analyzer 112b to acquire first image data in the image data acquisition under a first photographic condition. The first image data is temporarily accumulated in the image acquisition unit 112a by the process of step S202a′. The image analyzer 112b acquires the first image data by reading it from the image acquisition unit 112a. The controller 114 causes the image analyzer 112b to temporarily accumulate the acquired first image data. Thereafter, the process proceeds to step S282.

In step S282, the controller 114 causes the image analyzer 112b to acquire second image data in the image data acquisition under the second photographic condition. The second image data is temporarily accumulated in the image acquisition unit 112a by the process of step S202b′. The image analyzer 112b acquires the second image data by reading it from the image acquisition unit 112a. The controller 114 also causes the image analyzer 112b to temporarily accumulate the acquired second image data. Thereafter, the process proceeds to step S283.

In step S283, the controller 114 causes the recording image data generator 112d to generate recording image data. The recording image data generator 112d reads out the first image data and second image data accumulated in the image analyzer 112b in step S281 and step S282. The image analyzer 112b synthesizes the read first image data and second image data to thereby generate one frame of recording image data. Thereafter, the process proceeds to step S284.

In step S284, the controller 114 causes the recording image data generator 112d to correct the recording image data. The recording image data generator 112d reads out the region-specific correction map from the image analyzer 112b. In addition, the recording image data generator 112d corrects the recording image data generated in step S283 based on the read region-specific correction map. This correction processing is not always necessary and may be omitted for the reason described in the third embodiment. That is, according to the present embodiment, it is possible to provide an image processing apparatus 110 in which a data processor 112 performing image processing to image data acquired from an imaging unit 130 includes an image analyzer 112b that analyzes images for each of regions set for the imaging range of the imaging unit 130, based on image data of at least two types of frames (including accumulated and not-accumulated image data) acquired by the image acquisition unit 112a under different photographic conditions. Thereafter, the process proceeds to step S285.

In step S285, the controller 114 causes the recording image data generator 112d to accumulate recording image data. The recording image data generator 112d accumulates the recording image data generated in step S283 or the recording image data generated in step S283 and then corrected in step S284. Thereafter, the process proceeds to step S223 shown in FIG. 15B. The generation of recording image data described with reference to FIG. 15D is continued until the end of moving image photographing is instructed.

In step S223 shown in FIG. 15B, the controller 114 determines whether or not the end of moving image photographing has been instructed. For example, when the moving image button of the operation device 160 is pressed again by the user, the controller 114 determines that the end of moving image photographing has been instructed. In step S223, if it is determined that the end of moving image photographing has been instructed, the process proceeds to step S224. Conversely, if it is determined in step S223 that the end of moving image photographing is not instructed, the process proceeds to step S225.

In step S224, the controller 114 causes the recording image data generator 112d to generate a moving image file and record the generated moving image file in the moving image recorder 154 through the data processor 112. The generation and recording of moving image files are performed in the same manner as in the third embodiment. Thereafter, the process proceeds to step S241.

In step S225, the controller 114 determines whether or not still image photographing has been instructed. For example, when the release button of the operation device 160 is pressed by the user, the controller 114 determines that still image photographing has been instructed. In step S225, if it is determined that still image photographing has been instructed, the process proceeds to step S290. If it is determined in step S225 that still image photographing is not instructed, the process proceeds to step S241.

As described above, if it is determined in step S221 that the start of moving image photographing is not instructed, the process proceeds to step S231. In step S231, the controller 114 determines whether or not still image photographing has been instructed. This determination is made, for example, by the same process as in step S225. In step S231, if it is determined that the still image photographing has been instructed, the process proceeds to step S290. If it is determined in step S231 that still image photographing is not instructed, the process proceeds to step S241.

In step S290, the controller 114 causes the data processor 112 to generate still image recording image data. Thereafter, the process proceeds to step S233.

Hereinafter, generation of still image recording image data will be described with reference to FIG. 15E. FIG. 15E is a flowchart of the process of generating still image recording image data in step S290.

In step S291, the controller 114 causes the image analyzer 112b to acquire the first image data in the image data acquisition under the first photographic condition. The first image data is temporarily accumulated in the image acquisition unit 112a by the process of step S202a′. The image analyzer 112b acquires the first image data by reading it from the image acquisition unit 112a. The controller 114 also causes the image analyzer 112b to temporarily accumulate the acquired first image data. Thereafter, the process proceeds to step S292.

In step S292, the controller 114 causes the image analyzer 112b to acquire second image data in the image data acquisition under the second photographic condition. The second image data is temporarily accumulated in the image acquisition unit 112a by the process of step S202b′. The image analyzer 112b acquires the second image data by reading it from the image acquisition unit 112a. The controller 114 also causes the image analyzer 112b to temporarily accumulate the acquired second image data. Thereafter, the process proceeds to step S293.

In step S293, the controller 114 causes the recording image data generator 112d to generate recording image data. The recording image data generator 112d reads out the first image data and second image data accumulated in the image analyzer 112b in step S291 and step S292. The image analyzer 112b synthesizes the read first image data and the read second image data to thereby generate one frame of recording image data. Thereafter, the process proceeds to step S294.

In step S294, the controller 114 causes the recording image data generator 112d to correct the recording image data. The recording image data generator 112d reads out the region-specific correction map from the image analyzer 112b. In addition, the recording image data generator 112d corrects the recording image data generated in step S293 based on the read region-specific correction map. This correction process is not always necessary and may be omitted for the reason described in the third embodiment. Thereafter, the process proceeds to step S233 shown in FIG. 15B.

In step S233 shown in FIG. 15B, the controller 114 causes the recording image data generator 112d to generate a still image file and record the generated still image file in a still image recorder 152. The generation and recording of a still image file are performed in the same manner as in the third embodiment. Thereafter, the process proceeds to step S241.

In step S241, the controller 114 determines whether or not the stop of the image processing apparatus 110 has been instructed. For example, when the start/stop button of the operation device 160 is pressed again by the user, the controller 114 determines that the stop of the image processing apparatus 110 has been instructed. If it is determined in step S241 that the stop of the image processing apparatus 110 is not instructed, the process returns to step S201. Conversely, if it is determined in step S241 that the stop of the image processing apparatus 110 has been instructed, the controller 114 stops the image processing apparatus 110, and the image processing apparatus 110 returns to the standby state again.

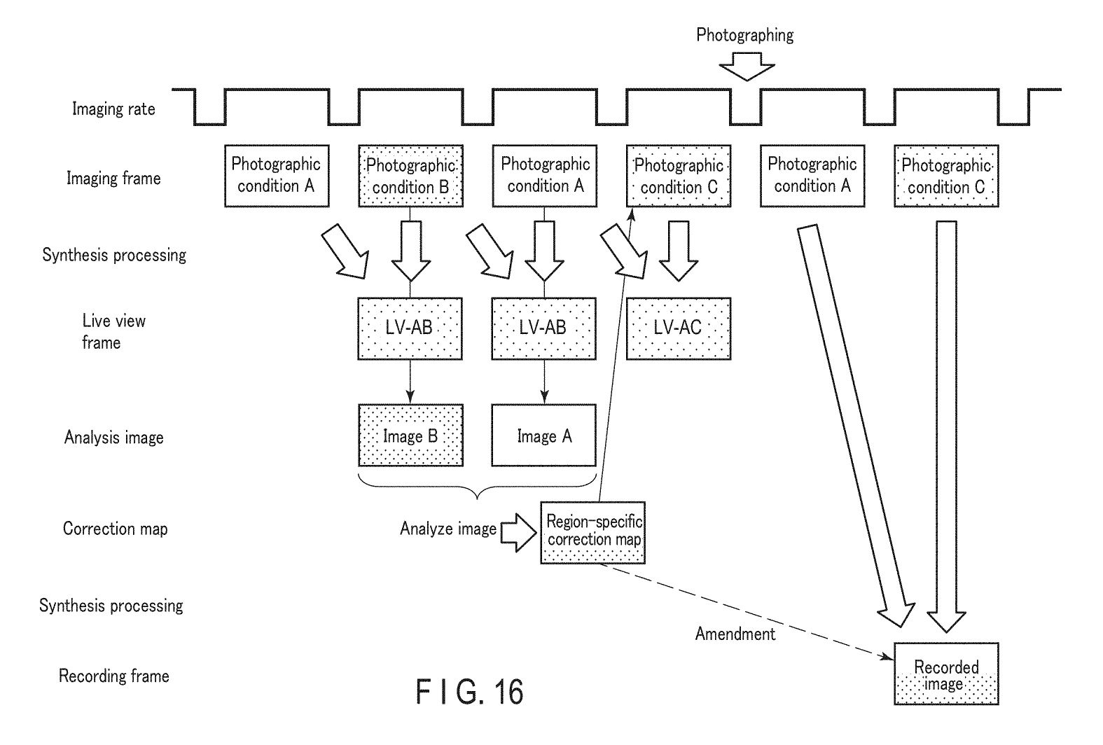

FIG. 16 is a timing chart showing the photographing operation performed in this way. FIG. 16 shows operations before and after photographing still images.

In FIG. 16, “imaging rate” indicates imaging timing. “Imaging frame” represents image data and photographic conditions in each photographing. In this figure, “photographing condition A” represents image data in the image data acquisition under a photographic condition A, “photographing condition B” represents image data in the image data acquisition under a photographic condition B, and “photographing condition C” represents image data in the image data acquisition under a photographic condition C.

“Live view frame” represents an LV image displayed on the display 140. “LV-AB” represents a live view image generated by synthesizing the image data in the image data acquisition under the photographic condition A and the image data in the image data acquisition under the photographic condition B. “LV-AC” represents a live view image generated by synthesizing the image data in the image data acquisition under the photographic condition A and the image data in the image data acquisition under the photographic condition C.

“Analysis image” represents image data to be subjected to image analysis. “Image A” represents image data in the image data acquisition under the photographic condition A, or image data obtained by performing addition processing to frames of image data, for example. “Image B” represents the image data in the image data acquisition under photographic condition B, or the image data obtained by performing addition processing to frames of image data, for example.

“Correction map” represents the “region-specific correction map” stored in the image analyzer 112b. “Recording frame” represents recorded image data generated by synthesizing the image data acquired under the “photographing condition A” and the image data acquired under the “photographing condition C”.

Initially, the image data in the “imaging frame” is composed of the image data of “photographing condition A” and the image data of “photographing condition B” that are alternately generated in the image data acquisition under the photographic condition A and the photographic condition B that are alternately modified. Also, the image data of “LV-AB” is generated as the image data of “live view frame” based on the image data of “photographing condition A” and the image data of “photographing condition B”.

In the present embodiment, for convenience of explanation, it is assumed that the first photographic condition is “photographing condition A” and the second photographic condition is “photographing condition B”. Namely, the first image data in the image data acquisition under the first photographic condition is the image data of “photographing condition A”, and the second image data in the image data acquisition under the second photographic condition is the image data of “photographing condition B”.

“Image A” and “Image B” as “Analysis image” are generated based on the image data of “photographing condition A” and the image data of “photographing condition B”, and based on them, the “region-specific correction map” has been updated. Also, based on the “region-specific correction map”, the second photographic condition has been modified from “photographing condition B” to “photographing condition C”. That is, the second image data in the image data acquisition under the second photographic condition has been modified from the image data of “photographing condition B” to the image data in “photographing condition C”.

As a result, the subsequent image data of the “imaging frame” is changed to the image data of “photographing condition A” and the image data in “photographing condition C” that are alternately generated in the image data acquisition under the photographic condition A and the photographic condition C which are alternately modified. Along with this, the image data of the “live view frame” is changed from the image data of “LV-AB” to the image data of “LV-AC”.

In the present embodiment, the image data of “photographing condition A” and the image data of “photographing condition B” alternately generated before modifying the photographic condition is “image data in the image data acquisition while the photographic condition is repeatedly modified according to the predetermined rule”, and the image data of “photographing condition A” and the image data of “photographing condition C” alternately generated after modifying the photographic condition is “image data in the image data acquisition while modifying the photographic condition based on the region-specific correction map”.

“Photographing” represents the timing at which still image photographing has been instructed. The image data of the “imaging frame” when the “photographing” has been instructed, namely, the image data of “photographing condition A” and the image data of “photographing condition C” is subjected to synthesis processing, whereby the image data of “Recorded image” of the “Recording frame” is generated. Furthermore, the image data of the “recorded image” may be corrected based on the “region-specific correction map” as necessary.

Several examples of photographic conditions A to C will be described below. However, the photographic conditions A to C are not limited to the examples described herein.

(a) The photographic condition A is exposure with a proper exposure adjusted to the background, the photographic condition B is exposure lower than the proper exposure, and the photographic condition C is exposure adjusted to a subject, e.g., exposure closer to the proper exposure than that of the photographic condition B.

By setting such photographic conditions A-C, for example, an image that has been difficult to identify the subject in the image of “LV-AB” before modifying the photographic condition becomes an image in which the subject can be easily identified in the image of “LV-AC” after modifying the photographic condition. Also, such a “recorded image” is obtained.

(b) The photographic condition A and the photographic condition B are illumination using white light, and the photographic condition C is illumination using narrow band light of violet light and green light.

Violet light and green light have characteristics that are easily absorbed by hemoglobin in the blood. In other words, violet light and green light are specific light for hemoglobin. Not only violet light and green light, but also light that shows a characteristic change for specific substances is widely called specific light. Violet light has a strong tendency to be absorbed by blood in surface blood vessels and green light has a strong tendency to be absorbed by blood in deep blood vessels.

In addition, light having a very narrow wavelength band such as laser light is called narrow band light. An observation utilizing narrow band light of such specific light is known as Narrow Band Imaging (NBI). In the narrow band imaging using narrow band light of violet light and green light, an image in which blood vessels are highlighted can be obtained.

By setting such photographic conditions A-C, for example, an image of “LV-AB” before modifying the photographic condition becomes an ordinary image obtained by white light observation, and an image of “LV-AC” after modifying the photographic condition becomes an image in which an image with highlighted blood vessels is overlapped on an ordinary image. Also, such a “recorded image” is obtained.

(c) The photographic condition A is illumination using white light, the photographic condition B is illumination using narrow band light of violet light and green light, and the photographic condition C is illumination using two types of infrared light having different wavelength bands.

An observation using illumination with two types of infrared light is known as Infra-Red Imaging (IRI). In the Infra-Red Imaging, an image in which information on blood vessels and blood flow in the deep mucosal is highlighted can be obtained.

By setting such photographic conditions A-C, for example, an image of “LV-AB” before modifying the photographic condition becomes an image in which an image with highlighted blood vessels is overlapped on an ordinary image, and an image of “LV-AC” after modifying the condition becomes an image in which an image with highlighted information on blood vessels and blood flow in the deep mucosal is overlapped on an ordinary image. Also, such a “recorded image” is obtained.

As described above, the photographic conditions A to C described in (a) to (c) are described as examples, and the photographic conditions A to C are not limited thereto.

In the present embodiment, an example in which the second photographic condition is modified from “photographing condition B” to “photographing condition C” is described; however, the first photographic condition may be modified from “photographing condition A” to “photographing condition D”. Furthermore, the modification of the first photographic condition and the second photographic condition is not limited to once, and the modification may be performed at any time as the region-specific correction map is updated.

As described above, according to the image processing apparatus of the present embodiment, an optimum image corresponding to a subject can be obtained by synthesizing image data in the image data acquisition while modifying the photographic condition based on the region-specific correction map, and further correcting the synthesized imaged data based on the region-specific correction map.

In the case where the modification of the photographic condition based on the region-specific correction map is performed during the image data acquisition of live view image data, an optimum live view image corresponding to the subject can be obtained.

Each of the processes performed by the controller 114 according to the present embodiment can also be stored as a program that can be executed by a computer as in the third embodiment.

In the above-described embodiment, the image is analyzed according to information prior to photographing, and the analysis result is reflected on photographing, but data at photographing may be used. It is also possible to use image data after photographing as necessary. Photographed results are temporarily stored, and information obtained from such photographed images is utilized when performing the actual recording.

In the embodiment, a part named as a section or a unit may be structured by a dedicated circuit or a combination of general purpose circuits, and may be structured by a combination of a microcomputer operable in accordance with pre-programmed software, a processor such as a CPU, or a sequencer such as an FPGA. In addition, a design where a part of or total control is performed by an external device can be adopted. In this case, a communication circuit is connected by wiring or wirelessly. Communication may be performed by means of Bluetooth, WiFi, a telephone line, or a USB. A dedicated circuit, a general purpose circuit, or a controller may be integrally structured as an ASIC. A specific mechanical functionality (can be substituted by a robot when a user images while moving) may be structured by various actuators and mobile concatenating mechanisms depending on the need, and may be structured by an actuator operable by a driver circuit. The driver circuit is controlled by a microcomputer or an ASIC in accordance with a specific program. The control may be corrected or adjusted in detail in accordance with information output by various sensors or peripheral circuits.

Although the embodiments of the present invention have been described with reference to the drawings so far, the present invention is not limited to these embodiments, and various modifications and changes may be made without departing from the gist thereof. Various modifications and changes mentioned here also include implementations in which the above-described embodiments are suitably combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising a data processor configured to perform image processing to image data acquired from an imaging unit, the data processor comprising:
an image acquisition unit configured to sequentially acquire image data from the imaging unit;
an image analyzer configured to update a region-specific correction map including correction information on each of regions set for an imaging range of the imaging unit, based on at least two frames of image data acquired by the image acquisition unit; and
a recording image data generator configured to generate recording image data in which one frame of image data acquired by the image acquisition unit is corrected based on the region-specific correction map.

2. The image processing apparatus according to claim 1 wherein the image analyzer includes an adder configured to perform addition processing to the at least two frames of image data, and the image analyzer updates the region-specific correction map based on one frame of image data included in the at least two frames of image data and one frame of image data acquired by addition processing.

3. The image processing apparatus according to claim 1 wherein the data processor is configured to cause a display to sequentially display an image corresponding to image data sequentially acquired.

4. The image processing apparatus according to claim 1 wherein the recording image data generator is configured to generate an image file including the recording image data, and the data processor causes a recording unit to record the image file.

5. The image processing apparatus according to claim 4, further comprising a clock configured to provide date and time information, and a controller configured to control the data processor, wherein the controller is configured to acquire the date and time information from the clock and cause the recording image data generator to include the acquired date and time information in the image file.

6. The image processing apparatus according to claim 5, wherein the controller is configured to cause the recording image data generator to include, in the image file, information of the region-specific correction map including positional information of the regions and correction information applied to each of the regions.

7. The image processing apparatus according to claim 1, wherein the data processor is configured to cause the imaging unit to perform photographing while repeatedly modifying a photographic condition and to sequentially output image data in photographing under each photographic condition.

8. The image processing apparatus according to claim 7, wherein the image acquisition unit is configured to sequentially acquire image data in the photographing while repeatedly modifying a photographic condition, and the image acquisition unit includes an HDR image data generator configured to generate HDR image data based on image data in photographing under a series of photographic conditions.

9. The image processing apparatus according to claim 1, further comprising a display configured to sequentially display images sequentially acquired by the image acquisition unit, and an operation device configured to at least allow a user to instruct recording of images.

10. The image processing apparatus according to claim 9, further comprising a recording unit configured to record the recording image data.

11. The image processing apparatus according to claim 10, further comprising the imaging unit configured to sequentially output image data.

12. An image processing method of performing image processing to image data acquired from an imaging unit, the method comprising:
sequentially acquiring image data from the imaging unit;
updating a region-specific correction map including correction information on each of regions set for an imaging range of the imaging unit based on at least two frames of image data acquired; and
generating recording image data in which one frame of image data acquired is corrected based on the region-specific correction map.

13. An image processing apparatus comprising a data processor configured to perform image processing to image data acquired from an imaging unit, the data processor including:
an image acquisition unit configured to sequentially acquire image data from the imaging unit; and
an image analyzer configured to analyze images for each of regions set for an imaging range of the imaging unit based on at least two frames of image data acquired by the image acquisition unit.

14. The image processing apparatus according to claim 13, wherein the data processor is configured to cause the imaging unit to start image data acquisition while modifying a photographic condition based on the region-specific correction map according to an operation of an operation device instructing recording of an image by a user.

15. The image processing apparatus according to claim 13, wherein the data processor further includes a recording image data generator configured to generate recording at least one frame of image data based on the image data acquired by the image acquisition unit and correct the recording image data based on the region-specific correction map.

16. The image processing apparatus according to claim 15, wherein the recording image data generator is configured to generate an image file including the recording image data, and the data processor is configured to cause a recording unit to record the image file.

17. The image processing apparatus according to claim 16 further comprising a controller configured to control the data processor, wherein the controller is configured to cause the data processor to include information of the region-specific correction map in the image file.

18. The image processing apparatus according to claim 13, wherein the image analyzer further includes an adder configured to perform addition processing to the at least two frames of image data and analyzes the image data based on one frame of image data included in the at least two frames of image data and one frame of image data acquired by addition processing.

19. The image processing apparatus according to claim 13, wherein the data processor is configured to cause the imaging unit to perform image data acquisition while repeatedly modifying the photographic condition in order to acquire live view image data and to sequentially output image data in image data acquisition in each photographic condition.

20. The image processing apparatus according to claim 19, wherein the image acquisition unit is configured to sequentially acquire image data in the image data acquisition while repeatedly modifying a photographic condition, and wherein the image acquisition unit comprises an HDR image data generator configured to generate HDR image data based on image data in image data acquisition under a series of photographic conditions.

21. The image processing apparatus according to claim 19, wherein the data processor is configured to cause the imaging unit to start image data acquisition while modifying a photographic condition based on the region-specific correction map during the acquisition of live view image data.

22. The image processing apparatus according to claim 13, wherein the imaging unit is capable of emitting illumination light while switching types of illumination light, and the data processor is configured to cause the imaging unit to emit illumination light while switching the types of illumination light to thereby perform image data acquisition while modifying a photographic condition based on the region-specific correction map.

23. The image processing apparatus according to claim 13, further comprising a display configured to sequentially display images sequentially acquired by the image acquisition unit, and an operation device configured to at least allow a user to instruct recording of images.

24. The image processing apparatus according to claim 23, further comprising a recording unit configured to record the image data.

25. The image processing apparatus according to claim 24, further comprising the imaging unit configured to sequentially output the image data.

26. An image processing method of performing image processing to image data acquired from an imaging unit, the method comprising:
sequentially acquiring image data from the imaging unit; and
analyzing images for each of regions set for an imaging range of the imaging unit, based on at least two frames of image data acquired.
